(19) United States
(12) Patent Application Publication
(10) Pub. No.: US 2024/0278127 A1
(43) Pub. Date: Aug. 22, 2024

(54) GAME INTERACTION METHOD AND APPARATUS, AND ELECTRONIC DEVICE AND READABLE MEDIUM

(71) Applicant: NETEASE (HANGZHOU) NETWORK CO., LTD., Hangzhou, Zhejiang (CN)

(72) Inventors: Yuewen LEI, Hangzhou, Zhejiang (CN); Zhe HUANG, Hangzhou, Zhejiang (CN)

(73) Assignee: NETEASE (HANGZHOU) NETWORK CO., LTD., Hangzhou, Zhejiang (CN)

(21) Appl. No.: 18/567,038

(22) PCT Filed: Mar. 14, 2022
(86) PCT No.: PCT/CN2022/080581

§ 371 Date: Dec. 5, 2023

(30) Foreign Application Priority Data
Jun. 25, 2021 (CN) 202110714931.8

(51) Int. Cl. A63F 13/56; A63F 13/42; A63F 13/533

(52) U.S. Cl. CPC A63F 13/56; A63F 13/42; A63F 13/533; A63F 2300/308

(57) ABSTRACT

The present disclosure relates to a game interaction method, including: displaying, by means of a graphical user interface, a player character who wears an initial garment; determining a camouflage target object in the current game scene where the player character is located, wherein the camouflage target object comprises at least one of the following: a non-player character who wears a garment representing an identity attribute, or a virtual article that comprises a garment representing an identity attribute; and in response to a preset operation instruction, controlling the player character to acquire a target garment, which corresponds to the camouflage target object and represents an identity attribute, and changing the initial garment of the player character to the target garment, so that the player character wears the same garment as the garment of the identity attribute that corresponds to the camouflage target object.

### CROSS REFERENCES TO RELATED APPLICATIONS

The present disclosure is a U.S. National Stage Application of International Application No. PCT/CN2022/080581, filed on Mar. 14, 2022, which is based upon and claims priority to Chinese Patent Application No. 202110714931.8 titled with “GAME INTERACTION METHOD AND APPARATUS, AND ELECTRONIC DEVICE AND READABLE MEDIUM” and filed on Jun. 25, 2021, the entire contents of both of which are incorporated herein by reference for all purposes.

### TECHNICAL FIELD

The present disclosure relates to the field of game technologies, and in particular to a method for game interaction, an apparatus for game interaction, an electronic device, and a computer-readable medium.

### BACKGROUND

With the development of computer technologies and online game technologies, in order to give players a greater sense of accomplishment, satisfaction and fun in games, an ability to replace current body parts, clothing, weapons, etc. of game characters has become an important development goal of online games.

### SUMMARY

The present disclosure provides a method and apparatus for game interaction, an electronic device, and a computer-readable medium.

Embodiments of the present disclosure disclose a method for game interaction, wherein a graphical user interface is provided by an electronic terminal, and a content displayed by the graphical user interface includes a game scene, a player character, and a plurality of non-player characters located in the game scene; wherein the non-player characters wear clothing that represents an identity attribute, and clothing corresponding to different identity attributes has different clothing styles, and the non-player characters act in the game scene according to a default action logic. The method includes:
displaying the player character wearing initial clothing through the graphical user interface;
determining a disguisable target object in a current game scene where the player character is located, wherein the disguisable target object comprises at least one of: the non-player character wearing clothing representing an identity attribute or a virtual item that comprises the clothing representing the identity attribute; and
in response to a preset operation instruction, controlling the player character to acquire target clothing, wherein the target clothing represents an identity attribute corresponding to a disguisable target object, and replacing initial clothing of the player character with the target clothing to make the player character wear the same clothing as the clothing representing the identity attribute corresponding to the disguisable target object.

### BRIEF DESCRIPTION OF THE DRAWINGS

FIG. 1 is a flowchart of steps of a method for game interaction provided in an embodiment of the present disclosure;

FIG. 2 is a schematic diagram of a game interface provided in an embodiment of the present disclosure;

FIG. 3 is a schematic diagram of a game interface provided in an embodiment of the present disclosure;

FIG. 4 is a schematic diagram of a game interface provided in an embodiment of the present disclosure;

FIG. 5 is a schematic diagram of a game interface provided in an embodiment of the present disclosure;

FIG. 6 is a schematic diagram of a game interface provided in an embodiment of the present disclosure;

FIG. 7 is a flowchart of steps of a method for game interaction provided in an embodiment of the present disclosure;

FIG. 8 is a schematic diagram of a game interface provided in an embodiment of the present disclosure;

FIG. 9 is a schematic diagram of a game interface provided in an embodiment of the present disclosure;

FIG. 10 is a schematic diagram of a game interface provided in an embodiment of the present disclosure;

FIG. 11 is a flowchart of steps of a method for game interaction provided in an embodiment of the present disclosure;

FIG. 12 is a schematic diagram of a game map provided in an embodiment of the present disclosure;

FIG. 13 is a schematic diagram of a game interface provided in an embodiment of the present disclosure;

FIG. 14 is a schematic diagram of a game interface provided in an embodiment of the present disclosure;

FIG. 15 is a structural block diagram of an apparatus for game interaction provided in an embodiment of the present disclosure;

FIG. 16 is a block diagram of an electronic device provided in an embodiment of the present disclosure; and

FIG. 17 is a schematic diagram of a computer-readable medium provided in an embodiment of the present disclosure.

### DETAILED DESCRIPTION

In order to make the above objectives, features and advantages of the present disclosure more obvious and understandable, the present disclosure will be described in further detail below in conjunction with the accompanying drawings and specific implementations.

A method for game interaction in embodiments of the present disclosure can run on a terminal device or a server. The terminal device may be a local terminal device. When the method for game interaction runs on the server, it may be a cloud game.

In an implementation of the present disclosure, the cloud game refers to a gaming mode based on cloud computing. In a cloud game running mode, a running main body of a game program and a game picture presentation main body are separated, the storage and operation of the method for game interaction are done on a cloud game server, and a function of the cloud game client is used for the reception and transmission of data and the presentation of the game picture. For example, the cloud game client may be a display device with a data transmission function close to a user side, such as a mobile terminal, a TV, a computer, a handheld computer, etc.; but the terminal device for game data processing is the cloud game server in the cloud. During the game, the player operates the cloud game client to send an operation instruction to the cloud game server, and the cloud game server runs the game according to the operation instruction, encodes and compresses the data such as the game picture and returns it to the cloud game client via a network. Finally, the client performs decoding and outputs the game picture through the cloud game client.

In an implementation of the present disclosure, the terminal device may be a local terminal device. The local terminal device stores the game program and is used to present the game picture. The local terminal device is used to interact with the player through a graphical user interface, that is, it is conventional to download, install and execute the game program through an electronic device. There may be multiple ways for the local terminal device to provide the graphical user interface to the player. For example, the graphical user interface may be rendered and displayed on a display screen of the terminal, or provided to the player through holographic projection. For example, the local terminal device may include the display screen and a processor, and the display screen is used to present the graphical user interface including the game picture, the processor is used to run the game, generate the graphical user interface, and control the graphical user interface to be displayed on the display screen.

In embodiments of the present disclosure, an electronic terminal as the local terminal device is taken as an example for illustrative description. It can be understood that it may also be the cloud game client mentioned above, which is not limited by the present disclosure.

As an example, changing clothing for a game character can not only bring an aesthetic experience to a player, but also derive different gameplay based on changing the clothing for the character. For example, the player may complete a corresponding task by collecting designated clothing, or the designated clothing may also be put on the player character to complete the corresponding task, or sneak into a corresponding destination, etc.

In some embodiments of the present disclosure, in a stealth confrontation game, stealth may be combined with asymmetric competition to conduct chase and escape confrontation in different game scenes. For example, a game match may be composed of two chasing parties and four stealth parties. The stealth party has an advantage in terms of the number of persons and needs to avoid the sight of the chasing party and a guarding Non-player Character (NPC) in the game scene to sneak into a target place, complete a designated task and successfully evacuate. The chasing party is relatively powerful and may, with the assistance of the guarding NPC, detect the disguise of the stealth party and chase the stealth party in the game scene. In such games, the stealth party may acquire corresponding clothing for dressing up to achieve disguise and avoid the chase of the chasing party. In the related arts, the dressing up of the game character tends to be performed through the player character's own existing clothing. The dress-up method is too simple, and when the game scene is changeable, the player character's own clothing may not always satisfy a clothing requirement of each game scene, which may easily cause the player to lose a suitable game opportunity due to the inability to effectively dress-up during the game, thus giving the players a poor game experience.

It should be noted that the dress-up of the game character involved in the present disclosure may also be applied to other types of games, such as massively multiplayer online competitive games, clothing collection games, role-playing games, etc., which is not limited by the present disclosure.

In this regard, one of core inventive points of embodiments of the present disclosure is as follows. An identity attribute of a game character is associated with clothing, and clothing corresponding to different identity attributes has different clothing styles. The terminal displays a player character wearing initial clothing through a graphical user interface. During a game, the terminal may determine a disguisable target object in a current game scene where the player character is located, and the disguisable target object includes at least one of: a non-player character wearing clothing that represents an identity attribute or a virtual item including the clothing that represents the identity attribute. The player may input a corresponding operation instruction according to an actual need, and the terminal controls the player character to acquire target clothing of an identity attribute corresponding to the disguisable target object, and the initial clothing of the player character is replaced with the target clothing. The diversity of the game character dress-up is enriched through different disguisable target objects, which can satisfy different needs of the player and realize the player character dress-up. Moreover, through the target clothing, the player character can be disguised as a game character with the corresponding identity, which achieves the “disguise” of the player character in the game scene, and improves the game fun.

In embodiments of the present disclosure, the player character may be a character controlled by the player, and the non-player character may be a character controlled by a system. During the game, different players may control their respective player characters to play in the game scene. At the same time, the game scene may include several different non-player characters, which may include non-interactive non-player characters and interactive non-player characters. For the non-interactive non-player character, it may only play a decorative role in the game, and for the interactive non-player character, it may interact with the player character if a certain condition is satisfied, such as attacking the player character, chatting with the player character, being attacked by the player character, being carried by the player character, etc. In embodiments of the present disclosure, the player character as a character controlled by a player to which the local terminal belongs and the non-player character as an interactive character are taken as an example for illustrative description. It can be understood that this is not limited by the present disclosure.

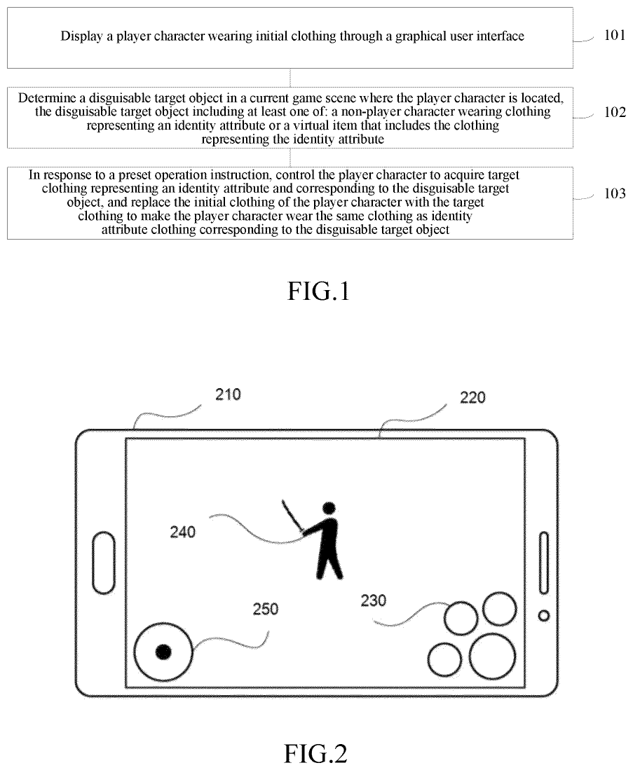

Specifically, reference is made to FIG. 1, which illustrates a flowchart of steps of a method for game interaction provided in an embodiment of the present disclosure. A graphical user interface is provided by an electronic terminal, and a content displayed by the graphical user interface includes a game scene, a player character, and a plurality of non-player characters located in the game scene. The non-player character wears clothing that represents an identity attribute, and clothing corresponding to different identity attributes has different clothing styles. The non-player character acts in the game scene according to a default action logic. The method may specifically include steps S101 to S103.

In the step 101, the player character wearing initial clothing is displayed by the graphical user interface.

During the game, the content displayed by the graphical user interface of the terminal may include the game scene, the player character, and the plurality of non-player characters located in the game scene. The player character wears the initial clothing at the beginning of the game (that is, when the player character is born), and the non-player character in the game scene may wear the clothing that represents the identity attribute. The clothing corresponding to the different identity attributes has the different clothing styles, and the non-player character may act in the game scene according to the default action logic.

For example, the identity attribute may include a waiter, a guard, a security guard, an administrator, etc., and the different identity attributes may correspond to the different clothing styles. Moreover, if game characters have gender differences, the identity attributes also have corresponding gender differences, and the clothing styles may also be associated with the gender and so on.

During the game, the player may control the player character through an interactive control provided in a game interface to perform corresponding game content. For example, the interactive control that may be provided in the game interface includes a movement control, a skill control, a shooting control, a disguise control, a jumping control, a standing control, etc. The interactive control may include an interactive control that is permanently displayed on the game interface, or may include an interactive control that is displayed on the game interface when the player character satisfies a corresponding condition. Accordingly, the player can control the player character to perform the corresponding interactive action through the corresponding interactive control.

Reference is made to FIG. 2, which illustrates a schematic diagram of a game interface provided in an embodiment of the present disclosure. A graphical user interface 220 may be obtained by executing a game software application on a processor of an electronic terminal 210 and rendering it on a touch display of the electronic terminal 210. The graphical user interface 220 includes at least one function control 230, and may further include a virtual game character 240 and a movement control 250. The function control 230 may include the disguise control, the standing control, the squat control, and so on.

In a specific implementation, the movement control 250 may be provided at the lower left of the graphical user interface 220, and the game character 240 is controlled to displace and/or rotate in the game scene according to an operation received by the movement control 250. A plurality of function controls 230 are provided at the lower right of the graphical user interface 220 to provide the player with different control operations. Therefore, in embodiments of the present disclosure, it is convenient for the player to use the left hand to control the game character to displace and perform the perspective rotation in the game scene, and to control different function controls through the right hand to control the virtual object. Moreover, in addition to controlling the game character in the game scene through control icons (the movement control and the function control, etc.) displayed by the graphical user interface, the player may also use the gyroscope, 3D Touch and other functions of the terminal device to control the game character.

It should be noted that in embodiments of the present disclosure, the interactive control that controls the movement and/or rotation of the player character, the function control being provided at the lower right of the graphical user interface and the movement control being provided at the lower left of the graphical user interface are taken as an example for illustrative description. It can be understood that the user can set the position of the interactive control according to his or her own preferences. For example, the interactive control is provided at the lower left, upper right, etc., which is not limited by the present disclosure.

In embodiments of the present disclosure, the content displayed by the graphical user interface of the terminal may include part of the game scene, the player character located in the game scene, and the corresponding interactive control. The game scene may change as the player character moves in the game scene. Specifically, the terminal may acquire a current orientation of the player character in the game scene, and determine a presentation field-of-view picture of the game scene in the graphical user interface based on the current orientation. The presentation field-of-view picture may be a picture visible in the current orientation of the player character. As the orientation and the position of the player character change, the presentation field-of-view picture also changes accordingly.

In the game, the game scene may include a birth area, an ordinary area, an occupation area, an intersection area, etc. The birth area may be a birth position of the player character at the beginning of the game. The ordinary area may be a scene area where the player character can move, acquire a clue and the like. The occupation area may include an occupation device, and the player may control the player character to interact with the occupation device to acquire the corresponding game progress. The intersection area may include an intersection device, and upon the completion of the interaction with the occupation device, the player may control the player character to interact with the intersection device to complete the task submission. For the player character, the player may dress up (replacing the current clothing/costume, etc.) the controlled player character in the game, to achieve game intentions such as “disguise”, “passage”, and “clue acquisition”.

It should be noted that an overall process of the game can develop in terms of birth-dress-up-occupation-intersection-occupation, etc. During the game, one player party controls the game character to carry out processes such as occupation-intersection, while the other player party controls the game character to defend, thereby realizing non-competitive confrontation between players in the game.

In a specific implementation, as for the clothing of the player character, the player character can have his/her own initial clothing when he/she is born. The player needs to acquire the clothing during the game for dress-up. Through the dress-up of the player character, the player character may be disguised or camouflaged as a character corresponding to the current clothing in order to reach a relevant area in the game scene, or realize the “disguise” through the dress-up to avoid the chasing of an enemy player character, etc.

In the step 102, a disguisable target object in a current game scene where the player character is located is determined, and the disguisable target object includes at least one of: a non-player character wearing clothing that represents an identity attribute or a virtual item that includes the clothing representing the identity attribute.

There may be the corresponding disguisable target object in the game scene, and the player may perform the dress-up of the player character by means of the disguisable target object. The disguisable target object may include the non-player character wearing the clothing that represents the identity attribute or the virtual item that includes the clothing representing the identity attribute, etc., for example, a NPC wearing clothing that represents the waiter, a NPC wearing clothing that represents the security guard, a clothing bag including the waiter clothing, a clothing bag including the security guard clothing, etc., so that the player can control the player character to acquire the clothing that represents the identity attribute from the virtual item, or acquire the clothing that represents the identity attribute from the NPC, and in turn the player character can wear the same clothing as the clothing representing the identity attribute and corresponding to the disguisable target object.

In an embodiment of the present disclosure, the terminal may acquire the current orientation of the player character in the game scene, and determine the presentation field-of-view picture of the current game scene in the graphical user interface based on the current orientation; and display the disguisable target object when detecting the disguisable target object exists in the presentation field-of-view picture.

In a specific implementation, the player may switch a perspective of the player character through the corresponding interactive control. During the switching, the terminal can update the presentation field-of-view picture in real time, and display the disguisable target object when detecting the disguisable target object in the updated field-of-view picture, so that the player controls the player character to approach the disguisable target object, thereby realizing the dress-up of the player character.

In another embodiment of the present disclosure, the terminal may; in response to an attack instruction that controls the player character to attack the non-player character, determine a first target non-player character, and control the player character to attack the first target non-player character. In response to the player character successfully attacking the first target non-player character, the terminal may place the first target non-player character in a downed state to make the first target non-player character become the disguisable target object, so that the player to control the player character to acquire the clothing of the disguisable target object in the downed state to realize the dress-up of the player character. In this way, the player character wears the same clothing that represents the identity attribute worn by the non-player character.

In a specific implementation, since the game scene includes the plurality of non-player characters wearing the clothing that represents the identity attribute, the player may control the player character to acquire the corresponding clothing from the non-player character. The non-player character is not “at the mercy” of the player character for clothing acquisition. Instead, the non-player character needs to be in a specific state before the player character can acquire the corresponding clothing. For example, the non-player character is in the downed state, or the non-player character is in a dead state, etc.

In a process that the player controls the player character to approach the first target non-player character (from who the player wants to acquire the clothing), the terminal may acquire first position information between the player character and the first target non-player character in real time, and the first position information may include a first relative distance and a first relative angle. If the terminal detects that the first relative distance is less than or equal to a preset distance threshold, and the first relative angle is less than or equal to a preset angle threshold, it may display an attack control in the graphical user interface. After the player touches the attack control, the terminal controls the player character to attack the first target non-player character in response to a touch operation for the attack control.

In some embodiments of the present disclosure, in a process that the player character attacks the first target non-player character, the terminal may control the player character to perform a corresponding attack operation based on a positional relationship between the player character and the first target non-player character. Specifically, the positional relationship may include that the player character is located in front of the first target non-player character (180 degrees from the orientation of the non-player character), and the player character is located behind the first target non-player character (180 degrees from the back of the non-player character). Then, in response to the touch operation for the attack control, the terminal may control the player character to perform a first attack for the first target non-player character if the player character is located in front of the first target non-player character, and control the player character to perform a second attack for the first target non-player character if the player character is located behind the first target non-player character. In the game, if the player character attacks from the front of the non-player character, the non-player character will perceive the operation of the player in this case. Therefore, in order to improve the realism of the game, the player character may be controlled to perform an attack action with a relatively long attack duration. If the player character attacks from the back of the non-player character, a “sneak attack” may be achieved, and the player character may be controlled to perform an attack operation with a relatively short attack duration, so that in the process of the player controlling the player character to attack the non-player character, the player character is controlled to perform different attack operations through the determination of the positional relationship between the player character and the non-player character, effectively improving the realism of the game.

After the player character successfully knocks down the first target non-player character, the terminal may use the first target non-player character in the knocked down state as the disguisable target object, so that the player controls the player character to acquire the clothing of the disguisable target object in the downed state, thereby realizing the dress-up of the player character. In this way; the player character wears the same clothing that represents the identity attribute worn by the non-player character.

By setting the corresponding disguisable target object in the game, or the player actively controlling the player character to attack the non-player character to make the non-player character become the disguisable target object, it is convenient for the player to control the player character to acquire the corresponding clothing.

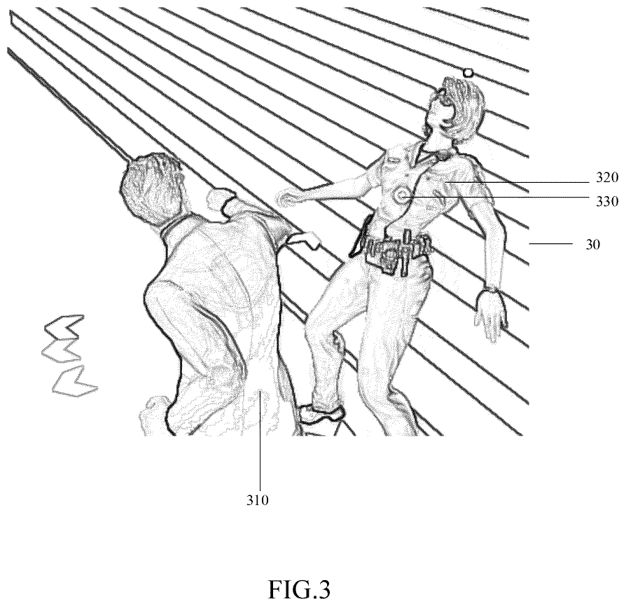

In an example, reference is made to FIG. 3, which illustrates a schematic diagram of a game interface provided in an embodiment of the present disclosure. A game interface 30 is displayed by the graphical user interface of the terminal, and the game interface 30 may include a player character 310 and a non-player character 320. In a case that the player controls the player character 310 to approach the non-player character 320 from the front, if a relative distance between the player character 310 and the non-player character 320 is less than or equal to 3 meters, and a relative angle between an orientation of the player character 310 and a line connecting the player character and the non-player character 320 is less than or equal to 45°, an attack identity 330 may be displayed on the body of the non-player character 320, and the corresponding attack control (not shown in the figure) may be displayed in the graphical user interface. When the player touches the attack control, the terminal can control the player character 310 to attack the non-player character 320 from the front, which is specifically embodied as that the terminal may play a long attack animation, and after the animation ends, the non-player character 320 is placed in the downed state, so that the player controls the player character 310 to acquire the clothing on the non-player character 320 and complete the dress-up. In this way, the player character wears the same clothing as the clothing that represents the identity attribute worn by the attacked non-player character.

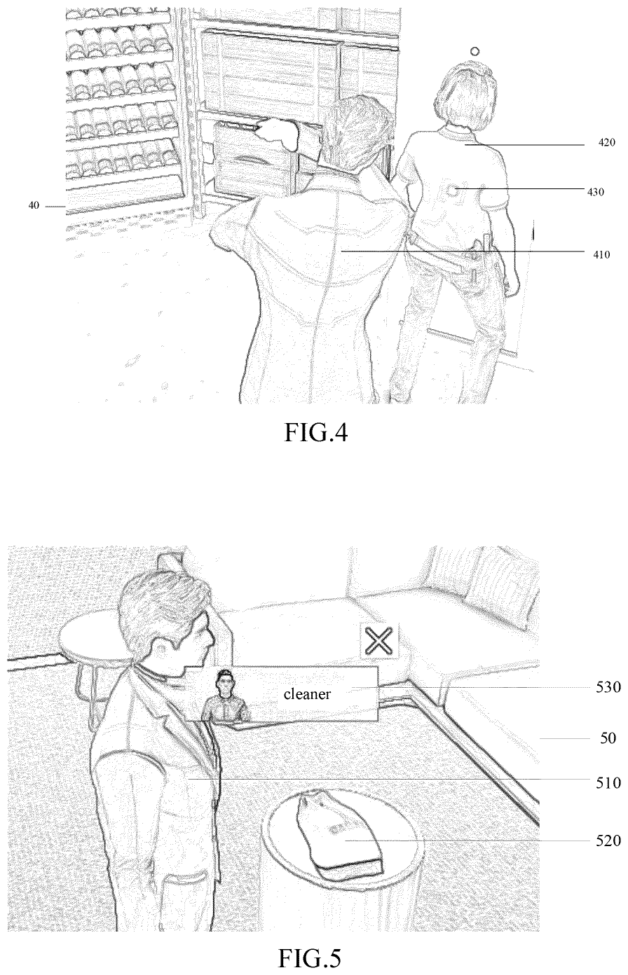

Reference is made to FIG. 4, which illustrates a schematic diagram of a game interface provided in an embodiment of the present disclosure. A game interface 40 is displayed by the graphical user interface, and the game interface 40 may include a player character 410, a non-player character 420 and an attack identity 430. The back attack of the player character is similar to the front attack process, which will not be repeated here. For the corresponding the content, reference may be made to the above description.

It should be noted that in embodiments of the present disclosure, the player controlling the player character to actively attack the non-player character is taken as an example for illustration. In another case, the player only needs to control the player character to move to a certain range of the non-player character to trigger the player character to attack the non-player character, without the player having to input the attack instruction to cause the player character to attack the non-player character, which is not limited by the present disclosure.

In the step 103, in response to a preset operation instruction, the player character is controlled to acquire target clothing, the target clothing represents the identity attribute corresponding to the disguisable target object, and the initial clothing of the player character is replaced with the target clothing to make the player character wear the same clothing as the clothing representing the identity attribute corresponding to the disguisable target object.

In embodiments of the present disclosure, the preset operation instruction may include different operation instructions, such as a skill release instruction input by the player character, a control touch operation, a clothing put away instruction, etc. In response to the preset operation instruction input by the player, the terminal may control the player character to acquire the target clothing that represents the identity attribute and corresponding to the disguisable target object, and replace the initial clothing of the player character with the target clothing, realizing the dress-up of the player character and enriching the diversity of the game character dress-up, which can satisfy different needs of the player. In addition, providing the more interesting dress-up manner allows the player to “disguise” the game character through the target clothing in the game, which improves the game fun and game experience.

In an embodiment of the present disclosure, the content displayed by the graphical user interface of the terminal further includes a skill control of the player character. In response to a touch operation for the skill control, the terminal can control the player character to copy the target clothing that represents the identity attribute and corresponding to the disguisable target object, and replace the initial clothing of the player character with the target clothing, so that the player character wears the same clothing as the clothing representing the identity attribute corresponding to the disguisable target object.

In a specific implementation, the player character may have a corresponding game skill, and different game skills may correspond to different skill controls. In a case that the player wants to perform the dress-up of the game character, if the game skill of the player character includes a copy skill (or other skills that can acquire from the non-player character the clothing that represents the identity attributes), the player may touch the corresponding skill control to trigger the player character to release the copy skill to copy the target clothing that represents the identity attribute from the disguisable target object, and then replace the initial clothing of the player character with the target clothing.

In another embodiment of the present disclosure, the terminal may acquire a second position information between the player character and the disguisable target object in the current game scene, and the second position information includes a second relative distance and a second relative angle. If the second position information satisfies a first preset condition, the terminal may display in the graphical user interface a dress-up control for the disguisable target object. And then in response to a touch operation for the dress-up control, the terminal may control the player character to acquire the target clothing, the target clothing represents the identity attribute corresponding to the disguisable target object, and replace the initial clothing of the player character with the target clothing, so that the player character wears the same clothing as the clothing representing the identity attribute corresponding to the disguisable target object.

Moreover, in a process of displaying the dress-up control, the terminal may acquire a current identity attribute corresponding to clothing currently worn by the player character and the target identity attribute corresponding to the disguisable target object, and then compare the current identity attribute with the target identity attribute. If the current identity attribute is the same as the target identity attribute, it indicates that the current clothing of the player character is the same as the clothing corresponding to the disguisable target object, the player cannot dress up the player character, and then the terminal can set the dress-up control to an inoperable state. If the current identity attribute is different from the target identity attribute, it indicates that the current clothing of the player character is different from the clothing corresponding to the disguisable target object, the player can dress up the player character, and then the terminal can set the dress-up control to an operable state, so that the player can perform the dress-up of the player character through the dress-up control according to actual needs, realizing the identity disguise of the player character.

In a specific implementation, the terminal may acquire the current orientation of the player character in the game scene, and determine the presentation field-of-view picture of the game scene in the graphical user interface based on the current orientation. Then in response to detecting that there is the disguisable target object in the presentation field-of-view picture, the terminal may acquire the second position information between the disguisable target object and the player character. If the second position information satisfies the first preset condition, the terminal may display the dress-up control for the disguisable target object in the graphical user interface. The current orientation of the player character may be determined through a virtual camera. A position of the virtual camera moves as the player character moves in the game scene, and its orientation may be consistent with the orientation of the player character. As an example, the orientation of the player character can be changed through an orientation control area, a perspective switching control, the movement control, etc. When the terminal detects that there is the disguisable target object in the presentation field-of-view picture, it will not display the dress-up control in the graphical user interface at this time, and the terminal may first acquire the position information between the disguisable target object and the player character in the game scene, such as the relative distance and the relative angle, etc. When the relative distance is less than or equal to 3 meters and the relative angle is less than or equal to 45°, the terminal determines that the player wants to interact with the disguisable target object, and displays the dress-up control for the disguisable target object in the graphical user interface, and displays the corresponding identity attribute in the dress-up control at the same time, so that the player can learn, based on the identity attribute, what character identity the clothing worn by the disguisable target object corresponds to, and then determine whether to perform the dress-up of the player character through the disguisable target object.

When the player touches the dress-up control, the terminal may respond to the touch operation for the dress-up control, and dress up the player character and perform a display operation for the disguisable target object according to a type of the disguisable target object. Specifically; if the disguisable target object is the virtual item (such as the clothing bag, etc.), the terminal may control the player character to acquire the target clothing that represents the identity attribute from the virtual item, replace the initial clothing of the player character with the target clothing, and remove the virtual item from the graphical user interface. If the disguisable target object is the non-player character, the terminal may control the player character to acquire the target clothing that represents the identity attribute from the non-player character, replace the initial clothing of the player character with the target clothing, and remove the target clothing worn by the non-player character, leaving the non-player character in an undressed state. The number of uses of the clothing representing the identity attribute worn by the disguisable target object is limited. When one of the player characters acquires the clothing, the virtual item containing the clothing is destroyed. Alternatively, after the player character acquires the clothing of the non-player character, the non-player character is left in the undressed state, making the dress-up gameplay in the game more interesting, thereby greatly improving the player game experience.

In an example, reference is made to FIG. 5, which illustrates a schematic diagram of a game interface provided in an embodiment of the present disclosure. The content displayed by the graphical user interface of the terminal includes a game interface 50, and the game interface 50 may include a player character 510 and a clothing bag 520. When a relative distance between the player character and the clothing bag is less than or equal to 3 meters, and an angle between the player character's current orientation and a line connecting the player character and the clothing bag is less than or equal to 45°, the terminal can display a dress-up control 530 in the graphical user interface, and display a corresponding identity attribute (e.g., a cleaner) in the dress-up control 530, so that the player can acquire the clothing corresponding to the cleaner by touching the dress-up control 530. The terminal can replace the current clothing of the player character with the clothing corresponding to the cleaner, and remove the clothing bag 520 from the current game interface.

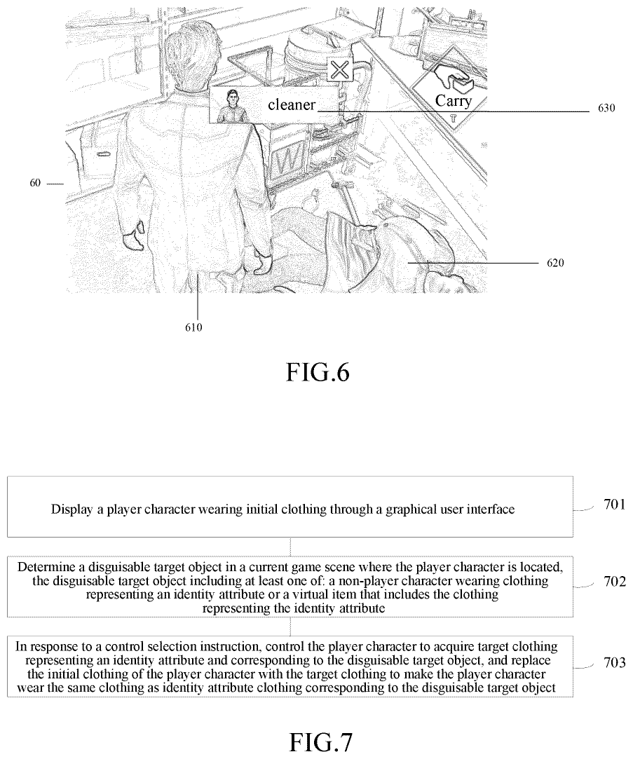

Reference is made to FIG. 6, which illustrates a schematic diagram of a game interface provided in an embodiment of the present disclosure. The content displayed by the graphical user interface of the terminal includes a game interface 60, and the game interface 60 may include a player character 610 and a non-player character 620, where the non-player character 620 may be a non-player character wearing clothing corresponding to the identity attribute. When a relative distance between the player character 610 and the non-player character is less than or equal to 3 meters, and an angle between the player character's current orientation and a line connecting the player character and the non-player character is less than or equal to 45°, the terminal can display a dress-up control 630 in the graphical user interface, and display a corresponding identity attribute (e.g., the cleaner) in the dress-up control 630, so that the player can acquire the clothing corresponding to the cleaner by touching the dress-up control 630. The terminal can replace the current clothing of the player character with the clothing corresponding to the cleaner, and removes the clothing on the non-player character 620 to leave it in the undressed state. In addition, for a process of the player controlling the player character to attack the non-player character to acquire the clothing, reference may be made to the above process, which will not be described in details here.

In addition, in embodiments of the present disclosure, the terminal may also, in response to detecting that the dress-up of the player character has completed, put the initial clothing into the backpack corresponding to the player character, or remove the initial clothing from the player character and display in the current game scene a target virtual item corresponding to the initial clothing. The target virtual item is only visible to a user to whom the player character belongs.

Specifically, it may be set that the player character can only have one set of clothing. After the completion of the dress-up, the terminal can remove the player character's last set of clothing, and display the corresponding virtual item (such as the clothing bag, etc.) in the game scene. The virtual item can only be visible to the user to whom the player character completing the dress-up belongs. For example, player “A” controls player character “a” to take off clothing \textcircled{1}, then the terminal can display a clothing bag corresponding to the clothing \textcircled{1} in the game scene, and the clothing bag can only be visible to player “A”, and are not visible to other players. In addition, it may also be set that the player character can have a plurality of set of clothing, and the player can put the obtained clothing into the player character's backpack, so that the player can choose, according to the game progress, the appropriate clothing in real time for dress-up. By providing different clothing processing manners, the gameplay of the player can be enriched, improving the game experience.

It should be noted that embodiments of the present disclosure include but are not limited to the above examples. It can be understood that under the guidance of the idea of embodiments of the present disclosure, the corresponding determination process may also be implemented by setting other thresholds, conditions, etc., which is not limited by the present disclosure.

In embodiments of the present disclosure, the terminal may display the player character wearing the initial clothing through the graphical user interface. During the game, the terminal may determine the disguisable target object in the current game scene where the player character is located, and then in response to the preset operation instruction, control the player character to acquire the target clothing, the target clothing represents the identity attribute corresponding to the disguisable target object, and replace the initial clothing of the player character with the target clothing. Therefore, by associating the identity attribute with the clothing in the game, the player can acquire the corresponding target clothing used to represent the corresponding identity attribute through the disguisable target object, realizing the dress-up of the player character and enriching the diversity of the game character dress-up, which can satisfy different needs of the player. In addition, providing the more interesting dress-up manner allows the player to “disguise” the game character through the target clothing in the game, which improves the game fun and game experience.

Reference is made to FIG. 7, which illustrates a flowchart of steps of a method for game interaction provided in an embodiment of the present disclosure. A graphical user interface is provided by an electronic terminal, and a content displayed by the graphical user interface includes a game scene, a player character, and a plurality of non-player characters located in the game scene. The non-player character wears clothing that represents an identity attribute, and clothing corresponding to different identity attributes has different clothing styles. The non-player character acts in the game scene according to a default action logic. The method may specifically include steps 701 to 703.

In the step 701, the player character wearing initial clothing is displayed by the graphical user interface.

In a specific implementation, as for the clothing of the player character, the player character can have his/her own initial clothing when he/she is born. The player needs to acquire the clothing during the game for dress-up. Through the dress-up of the player character, the player character may be disguised or camouflaged as a character corresponding to the current clothing in order to reach a relevant area in the game scene, or realize the “disguise” through the dress-up to avoid the chasing of an enemy player character, etc. For example, when the player character is born, the terminal may display the corresponding initial clothing according to a character identity of the player character. If the player character is an infiltrator, initial clothing corresponding to the infiltrator may be displayed. If the player character is a chaser, initial clothing corresponding to the chaser may be displayed, and so on. In the game, the infiltrator can perform the dress-up, to avoid the chasing of the chaser.

In the step 702, a disguisable target object in a current game scene where the player character is located is determined, and the disguisable target object includes at least one of: a non-player character wearing clothing that represents an identity attribute or a virtual item that includes the clothing representing the identity attribute.

There may be the corresponding disguisable target object in the game scene, and the player may perform the dress-up of the player character by means of the disguisable target object. The disguisable target object may include the non-player character wearing the clothing that represents the identity attribute or the virtual item that includes the clothing representing the identity attribute, etc., for example, a NPC wearing clothing that represents the waiter, a NPC wearing clothing that represents the security guard, a clothing bag including the waiter clothing, a clothing bag including the security guard clothing, etc.

In addition, in addition to the disguisable target object that already exists in the game scene, the player may also control the player character to actively attack the non-player character to acquire the clothing that represents the identity attribute worn by the non-player character, so as to achieve the dress-up.

In the step 703, in response to a control selection instruction, the player character is controlled to acquire target clothing, the target clothing represents the identity attribute corresponding to the disguisable target object, and the initial clothing of the player character is replaced with the target clothing to make the player character wear the same clothing as the clothing representing the identity attribute corresponding to the disguisable target object.

In embodiments of the present disclosure, the preset operation instruction may include different operation instructions, such as a skill release instruction input by the player character, a control touch operation, a clothing put away instruction, etc. In response to the preset operation instruction input by the player, the terminal may control the player character to acquire the target clothing that represents the identity attribute and corresponding to the disguisable target object, and replace the initial clothing of the player character with the target clothing, realizing the dress-up of the player character and enriching the diversity of the game character dress-up, which can satisfy different needs of the player. In addition, providing the more interesting dress-up manner allows the player to “disguise” the game character through the target clothing in the game, which improves the game fun and game experience.

In an embodiment of the present disclosure, the terminal may acquire second position information between the player character and the disguisable target object in the current game scene, and the second position information may include a second relative distance and a second relative angle. If the second relative distance is less than or equal to a preset distance threshold, and the second relative angle is less than or equal to a preset angle threshold, a dress-up control and a carrying control for the disguisable target object are displayed in the graphical user interface. The dress-up control can realize the dress-up of the player character, and the carrying control can realize the carrying of the disguisable target object, especially the carrying of the non-player character.

In a specific implementation, as the player controls the movement of the player character in the game scene, the terminal may determine a presentation field-of-view picture according to a current orientation of the player character. When the terminal detects that there is the disguisable target object in the presentation field-of-view picture, it will not display the dress-up control in the graphical user interface at this time, and the terminal may first acquire the position information between the disguisable target object and the player character in the game scene, such as the relative distance and the relative angle, etc. When the relative distance is less than or equal to the preset distance threshold and the relative angle is less than or equal to the preset angle threshold, the terminal determines that the player wants to interact with the disguisable target object, and displays the dress-up control for the disguisable target object in the graphical user interface, and display the corresponding target identity attribute in the dress-up control, so that the player can learn, based on the target identity attribute, what character identity the disguisable target object corresponds to, and then determine whether to perform the dress-up of the player character through the disguisable target object. For the dress-up process, reference may be made to the relevant descriptions of the above embodiments. The process is basically the same and will not be described again here.

For a specific disguisable target object, the carrying control for the disguisable target object may be displayed in the graphical user interface, so that the player can control, by selecting the carrying control, the player character to carry the disguisable target object. In some embodiments of the present disclosure, such disguisable target object may be a non-player character who is in a downed state (if it is a clothing bag, it only supports the dress-up or putting the clothing that represents the identity into the backpack, and the carrying cannot be performed). Accordingly, during the game, when the player controls the player character to attack the non-player character, or when the clothing of the corresponding non-player character is acquired, the non-player character may be carried to a hidden place to hide the corresponding character dress-up behavior, to avoid being discovered by the enemy player character, thereby enriching the gameplay of the player and improving the game experience.

If the disguisable target object is the clothing bag, the terminal may only display the dress-up control for the clothing bag in the graphical user interface, so that the player can perform the dress-up of the player character through the clothing bag. If the disguisable target object is a non-player character located in the presentation field-of-view picture and in the downed state, or a non-player character located in a storage object and in the downed state, the terminal may display the dress-up control and the carrying control for the non-player character in the graphical user interface. On the one hand, if the player wants to perform the dress-up through the clothing on the non-player character, the dress-up may be done through the dress-up control. On the other hand, if the player wants to carry the non-player character to the hidden place, the non-player character may be carried through the carrying control. In this way, on the one hand, different interactive controls may be provided according to different types of disguisable target objects, enriching the player's operation modes. On the other hand, the player can perform the dress-up of the player character through the disguisable target object, enriching the diversity of the dress-up of the game character, which can satisfy the different needs of the player.

In a specific implementation, in response to a touch operation for the carrying control, the terminal may control the player character to carry a second target non-player character, and set the second target non-player character to an un-selectable state. In some embodiments of the present disclosure, before the second target non-player character is carried, the terminal may; in response to the touch operation for the carrying control, acquire a character state of the second target non-player character. If the character state indicates that the second target non-player character is in a selectable state, the terminal may control the player character to carry, at a preset movement speed (such as 2 meters/second, etc.), the second target non-player character. During the carrying, the second target non-player character may be locked to make it in the un-selectable state, and in this state, if other player characters want to carry it, they cannot do so.

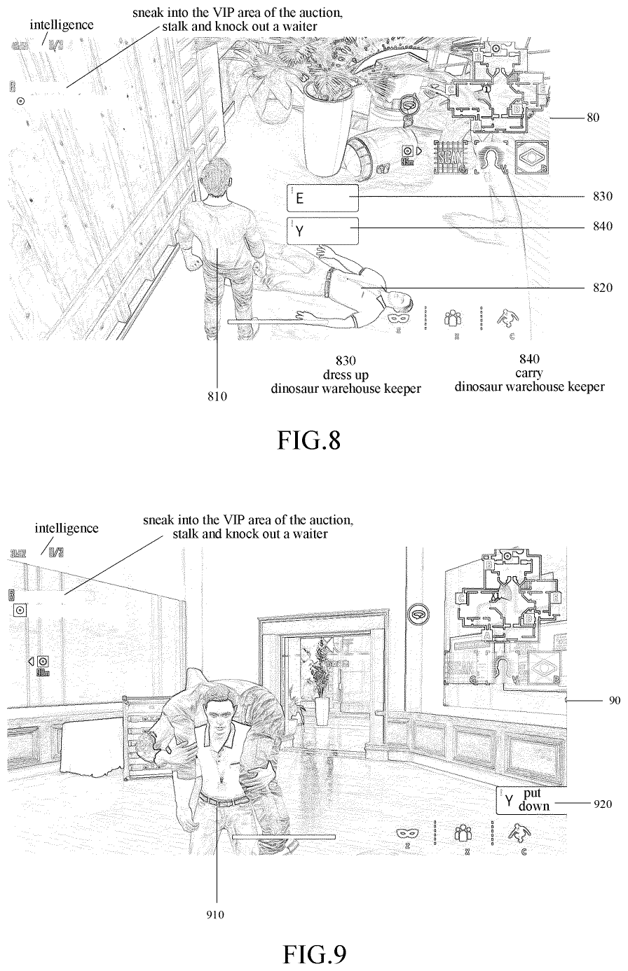

In an example, reference is made to FIG. 8, which illustrates a schematic diagram of a game interface provided in an embodiment of the present disclosure. The content displayed by the graphical user interface of the terminal includes a game interface 80, and the game interface 80 may include a player character 810 and a non-player character 820. When a relative distance between the player character 810 and the non-player character 820 is less than or equal to 3 meters, and an angle between the player character's current orientation and a line connecting the player character and the non-player character is less than or equal to 45°, the terminal may display a dress-up control 830 and a carrying control 840 in the graphical user interface, so that the player can perform the dress-up of the player character by selecting the dress-up control 830, and/or carry the non-player character 820 by selecting the carrying control 840. In this way, on the one hand, different interactive controls may be provided according to different types of disguisable target objects, enriching the player's operation modes. On the other hand, the player can perform the dress-up of the player character through the disguisable target object, enriching the diversity of the dress-up of the game character, which can satisfy the different needs of the player.

In an embodiment of the present disclosure, in a process of the player controlling the player character to carry the second target non-player character, if it is determined that a position where the player character is located is within a preset range of another non-player character, a threat value of the other non-player character is increased. When the threat value reaches a certain value, the terminal may control a non-player character whose threat value is greater than or equal to a preset threat threshold to change from the default action logic to a target logic, and control, according to the target logic, the non-player character to perform a target behavior for the player character. Alternatively, in the process of the player character carrying the second target non-player character, if a carrying action of the player character falls within the preset range of the other non-player character, the other non-player character is made to change from the default action logic to the target logic, the other non-player character is controlled according to the target logic to perform the target action for the player character, and an illegal alarm against the player character is issued. The illegal alarm may be used to prompt the opposite (enemy) player with the position information of the player character.

The carrying behavior of the player character for the non-player character in the game belongs to an illegal behavior, and such behavior can increase the threat value of other non-player characters to the player character within a certain range of the player character. For example, in a process of the player character carrying the non-player character, a sound may be made, and other non-player characters may hear the sound. Based on the special identity (infiltrator) of the player character, it will arouse the alertness of other non-player characters, thereby increasing the threat value of the non-player character to the player character. Alternatively, in the process of the player character carrying the non-player character, if the player character is seen by other non-player characters, an alarm will be triggered. A threat value against the player character of the non-player character who sees the carrying behavior can be set to the highest, thus triggering the change of the action logic of the non-player character.

In some embodiments of the present disclosure, the default action logic of the non-player character may be to move randomly in the game scene, and the target logic may be to move towards the player character in a direction and perform the target behavior for the player character, such as attacking, chasing, etc. Therefore, the corresponding threat value is set for the carrying behavior of the player character and the action logic of the non-player character is changed according to the threat value, which improves the playability and interest of the game.

In another embodiment of the present disclosure, in a process of the player controlling the player character to carry the second target non-player character, the terminal may; in response to detecting the presence of a storage object in the current game scene, acquire third position information between the storage object and the player character, and a storage state of the storage object. If the third position information and the storage state satisfy a second preset condition, the terminal may display a storage control corresponding to the storage object in the graphical user interface, and then in response to a touch operation for the storage control, the terminal may control the player character to carry the second target non-player character into the storage object.

In a specific implementation, the storage object may be an object provided in the game scene that may be used to accommodate the non-player character, such as a virtual cabinet, a virtual box, or the like. During the carrying, if the terminal detects that there is a storage object near the player character, it may acquire the relative distance and the relative angle between the player character and the storage object in the game scene. If a third relative distance is less than or equal to the preset distance threshold, a third relative angle is less than or equal to the preset angle threshold, and the storage state indicates that the number of non-player characters stored in the storage object is less than a preset number threshold, the terminal may display the storage control corresponding to the storage object in the graphical user interface. If the position information satisfies the condition, but the storage state indicates that the number of non-player characters stored in the storage object is equal to the preset number threshold, the terminal may lock the storage object and display a prompt identity (such as “This cabinet is full”, “This box is full”, etc.) in the graphical user interface. If the position information does not satisfy the condition, the terminal does not display the storage control or the prompt identity in the graphical user interface.

When the storage control is displayed, the player may control the player character to carry the second target non-player character into the storage object by touching the storage control, thereby realizing the “disposal” of the non-player character in the current game scene and realizing “the destroying of the evidence”. In this way, the player character may better disguise himself and prevent the player character from being discovered by the enemy player character.

In a process of the player character carrying the second target non-player character, or in a process of the player character carrying the second target non-player character into the storage object, an interrupt control is displayed in the graphical user interface. In response to a touch operation for the interrupt control, the terminal may control the player character to stop carrying the second target non-player character, or control the player character to stop carrying the second target non-player character to the storage object, and set a state of the second target non-player character to a selectable state.

In addition, in the process of the player character carrying the second target non-player character, in response to detecting that a carrying operation of the player character is interrupted, the player character is controlled to stop carrying the second target non-player character, and the state of the second target non-player character is set to the selectable state. Alternatively, in a process of the player character moving the second target non-player character into the storage object, in response to detecting that the carrying operation of the player character is interrupted, the player character is controlled to stop carrying the second target non-player character, and the state of the second target non-player is set to the selectable state.

In a specific implementation, the player can control, through the interrupt control, the player character to actively interrupt the carrying action for the second target non-player character. When the carrying is stopped, the second target non-player character may stay at the current position. Moreover, if the player character's carrying action is interrupted in the carrying process, for example, the player character is controlled, the player character is forced for displacement, the player character is in the melee combat, the player character performs a shooting operation, etc., the player character may stop the carrying action for the second target non-player character.

In some embodiments of the present disclosure, the process of the player character carrying the second target non-player character to the storage object may include a process of starting the carrying, a process of carrying to the storage object, and a process of completing the carrying. If the carrying action is interrupted in the process of starting the carrying, the second target non-player character may be directly placed in the current position. If the carrying action is interrupted in the process of carrying to the storage object, the second target non-player character will fall to the ground. If the carrying action is interrupted after the completion of the carrying, the second target non-player character is successfully moved to the storage object, and the second target non-player character in the game scene is “destroyed”, so that the player character as the infiltrator can attack the non-player character in the game to acquire the clothing or move the non-player character in the undressed state to the hidden place after acquiring the non-player character's clothing, so as to “destroy” the evidence and avoid being discovered by the chaser, which fully improves the playability; authenticity and fun of the game, thereby greatly improving the player's game experience.

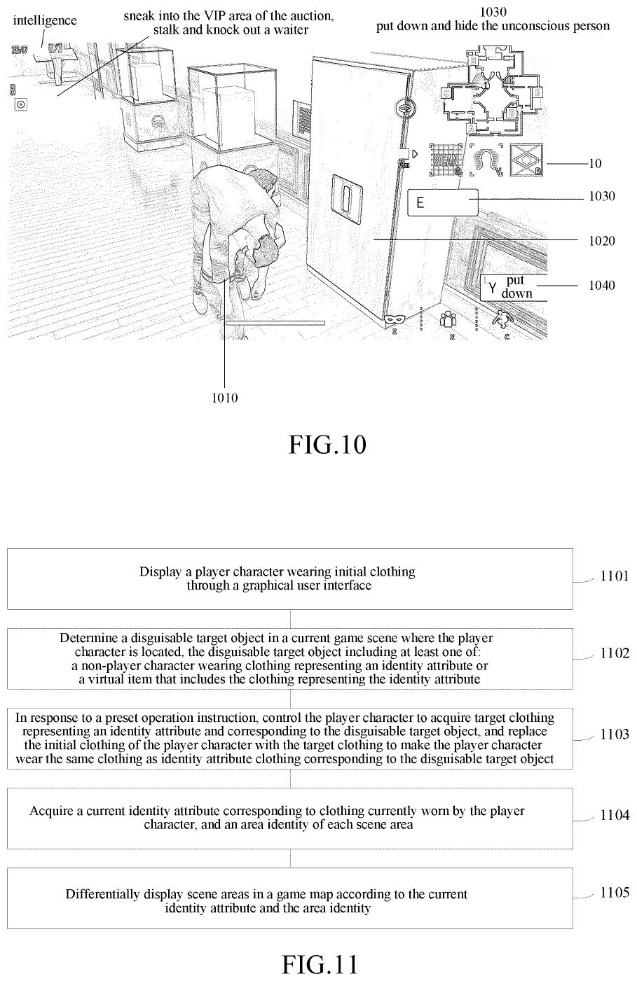

In an example, reference is made to FIG. 9, which illustrates a schematic diagram of a game interface provided in an embodiment of the present disclosure. The content displayed by the graphical user interface of the terminal includes a game interface 90, and the game interface 90 may include a player character 910 who is carrying a non-player character. During the carrying, an interrupt control 920 may be displayed in the graphical user interface. The player may control, by selecting (including touch or click) the interrupt control 920, the player character 910 to place the carried non-player character at a corresponding position point. In addition, reference is made to FIG. 10, which illustrates a schematic diagram of a game interface provided in an embodiment of the present disclosure. The content displayed by the graphical user interface of the terminal includes a game interface 10, and the game interface 10 includes a player character 1010 who is carrying a non-player character. During the carrying, if the terminal detects a cabinet 1020, and a relative distance between the cabinet 1020 and the player character 1010 is less than or equal to 3 meters, an angle between the player character's current orientation and a line connecting the player character and the cabinet is less than or equal to 45°, a storage control 1030 may be displayed in the graphical user interface, so that the player can carry the non-player character into the cabinet through the storage control 1030, so as to “destroy” the evidence and avoid being discovered by the chaser, which fully improves the playability, authenticity and fun of the game, thereby greatly improving the player's game experience. In addition, in the process of carrying the non-player character, the corresponding interrupt control 1040 may also be displayed in the interface. The carrying of the non-player character may be interrupted through the interrupt control 1040, including stopping carrying the non-player character in the game scene, stopping carrying the non-player character to the cabinet and stopping other carrying processes.

It should be noted that embodiments of the present disclosure include but are not limited to the above examples. It can be understood that under the guidance of the idea of embodiments of the present disclosure, the corresponding determination process may also be implemented by setting other thresholds, conditions, etc., which is not limited by the present disclosure.

In embodiments of the present disclosure, the terminal may display the player character wearing the initial clothing through the graphical user interface. During the game, the terminal may determine the disguisable target object in the current game scene where the player character is located, and then in response to the preset operation instruction, control the player character to acquire the target clothing, the target clothing represents the identity attribute corresponding to the disguisable target object, and replace the initial clothing of the player character with the target clothing. Therefore, by associating the identity attribute with the clothing in the game, the player can acquire the corresponding target clothing used to represent the corresponding identity attribute through the disguisable target object, realizing the dress-up of the player character and enriching the diversity of the game character dress-up, which can satisfy different needs of the player. In addition, providing the more interesting dress-up manner allows the player to “disguise” the game character through the target clothing in the game, which improves the game fun and game experience.

Reference is made to FIG. 11, which illustrates a flowchart of steps of a method for game interaction provided in an embodiment of the present disclosure. A graphical user interface is provided by an electronic terminal, and a content displayed by the graphical user interface includes a game scene, a player character, and a plurality of non-player characters located in the game scene. The non-player character wears clothing that represents an identity attribute, and clothing corresponding to different identity attributes has different clothing styles. The non-player character acts in the game scene according to a default action logic. The method may specifically include steps 1101 to 1105.

In the step 1101, the player character wearing initial clothing is displayed by the graphical user interface.

In a specific implementation, as for the clothing of the player character, the player character can have his/her own initial clothing when he/she is born. The player needs to acquire the clothing during the game for dress-up. Through the dress-up of the player character, the player character may be disguised or camouflaged as a character corresponding to the current clothing in order to reach a relevant area in the game scene, or realize the “disguise” through the dress-up to avoid the chasing of an enemy player character, etc. For example, when the player character is born, the terminal may display the corresponding initial clothing according to a character identity of the player character. If the player character is an infiltrator, initial clothing corresponding to the infiltrator may be displayed. If the player character is a chaser, initial clothing corresponding to the chaser may be displayed, and so on. In the game, the infiltrator can perform the dress-up, to avoid the chasing of the chaser.

In the step 1102, a disguisable target object in a current game scene where the player character is located is determined, and the disguisable target object includes at least one of: a non-player character wearing clothing that represents an identity attribute or a virtual item that includes the clothing representing the identity attribute.

There may be the corresponding disguisable target object in the game scene, and the player may perform the dress-up of the player character by means of the disguisable target object. The disguisable target object may include the non-player character wearing the clothing that represents the identity attribute or the virtual item that includes the clothing representing the identity attribute, etc., for example, a NPC wearing clothing that represents the waiter, a NPC wearing clothing that represents the security guard, a clothing bag including the waiter clothing, a clothing bag including the security guard clothing, etc.

In addition, in addition to the disguisable target object that already exists in the game scene, the player may also control the player character to actively attack the non-player character to acquire the clothing that represents the identity attribute worn by the non-player character, so as to achieve the dress-up.

In the step 1103, in response to a preset operation instruction, the player character is controlled to acquire target clothing, the target clothing represents the identity attribute corresponding to the disguisable target object, and the initial clothing of the player character is replaced with the target clothing to make the player character wear the same clothing as the clothing representing the identity attribute corresponding to the disguisable target object.

In embodiments of the present disclosure, the preset operation instruction may include different operation instructions, such as a skill release instruction input by the player character, a control touch operation, a clothing put away instruction, etc. In response to the preset operation instruction input by the player, the terminal may control the player character to acquire the target clothing that represents the identity attribute and corresponding to the disguisable target object, and replace the initial clothing of the player character with the target clothing, realizing the dress-up of the player character and enriching the diversity of the game character dress-up, which can satisfy different needs of the player. In addition, providing the more interesting dress-up manner allows the player to “disguise” the game character through the target clothing in the game, which improves the game fun and game experience.

In the step 1104, a current identity attribute corresponding to clothing currently worn by the player character, and an area identity of each scene area are acquired.

In the game, the game scene may be divided into a birth area, an ordinary area, an occupation area, an intersection area, etc. according to a function of the scene area. The birth area may be a birth position of the player character at the beginning of the game. The ordinary area may be a scene area where the player character can move, acquire a clue and the like. The occupation area may include an occupation device, and the player may control the player character to interact with the occupation device to acquire the corresponding game progress. The intersection area may include an intersection device, and upon the completion of the interaction with the occupation device, the player may control the player character to interact with the intersection device to complete the task submission. For the player character (a game character whose identity is the infiltrator), the player may dress up (replacing the current clothing/costume, etc.) the controlled player character in the game, to achieve game intentions such as “disguise”, “passage”, and “clue acquisition”.

In some embodiments of the present disclosure, different scene areas correspond to different area identities. For example, the game scene may include scene area \textcircled{1}, scene area \textcircled{2}, scene area \textcircled{3}, and scene area \textcircled{4}, and each scene area may correspond to a unique area identity area_id. Moreover, each set of clothing also corresponds to a unique identity attribute appearance_id. As the clothing currently worn by the player character changes, its corresponding identity attribute may also change accordingly.

In the step 1105, the scene area is differentially displayed in the game map according to the current identity attribute and the area identity.

During the game, the player is required to perform the dress-up of the player character to achieve game intentions such as “disguise”, “passage”, and “clue acquisition”. Therefore, respective disguise requirements may be set for different scene areas in the game scene (for example, the player character is required to wear the corresponding clothing that represents the identity attribute), so that the scene area may be differentially displayed in the game map according to the identity attribute corresponding to the clothing worn by the player character and the area identity of each scene area. In this way, the player can learn, through the differential display in the map, passage conditions of the player character wearing the current clothing in different scene areas during the game, which in turn helps the player to make corresponding game decisions.

In a specific implementation, the terminal may query a disguise passage level corresponding to each area identity from a preset passage level table by using the current identity attribute, and then divide in the game map the scene area into a regular passage area and an illegal passage area according to the disguise passage level, and set the illegal passage area to a different display style from the regular passage area. Through the differential display of different areas in the game map, the player can learn passage conditions of the clothing corresponding to the current identity attribute in the game scene, which in turn helps the player to make corresponding game decisions.

In some embodiments of the present disclosure, the passage level table may be a level table established based on different identity attributes and different area identities in the game map. The passage level table records disguise passage levels of different identity attributes in different areas of the game map. Specifically, it may be shown as follows:

| | area_id0 | area_id I | area_id II | area_idIII | area_idIV |
|---|---|---|---|---|---|
| appearance_id\textcircled{1} | 1 | 1 | 2 | 3 | 4 |
| appearance_id\textcircled{2} | 1 | 2 | 3 | 4 | 1 |
| appearance_id\textcircled{3} | 1 | 3 | 4 | 1 | 2 |
| appearance_id\textcircled{4} | 1 | 4 | 1 | 2 | 3 |

where, area_id0 may represent the birth area, in which the player character can pass freely while wearing clothing with any identity attribute. Specifically, disguise passage level 1 represents a safe area, disguise passage level 2 represents a transition area, disguise passage level 3 represents a departure area, and disguise passage level 4 represents an illegal area. The regular passage area may include the safe area and the transition area, and the illegal passage area may include the departure area and the illegal area. For the safe area and the transition area, the player character can pass freely while wearing the current clothing. For a scene area corresponding to the departure area, the player character is required to wear some specific clothing, and some clothing will be restricted. If the clothing currently worn by the player character is restricted by this scene area, the player character cannot pass freely. For a scene area corresponding to the illegal area, the player character is required to wear specified clothing, and all clothing except the specified clothing will be restricted. If the clothing currently worn by the player character is restricted by this scene area, the player character cannot pass freely.

It should be noted that the inability of the player character to pass freely in the game scene means that when the player character enters the departure area or the illegal area while wearing unqualified clothing, the system will determine that the player character has failed to disguise and will prompt. In addition, when the player character moves in such scene area, the player character is easily discovered by the enemy player character or the non-player character, revealing the disguise.

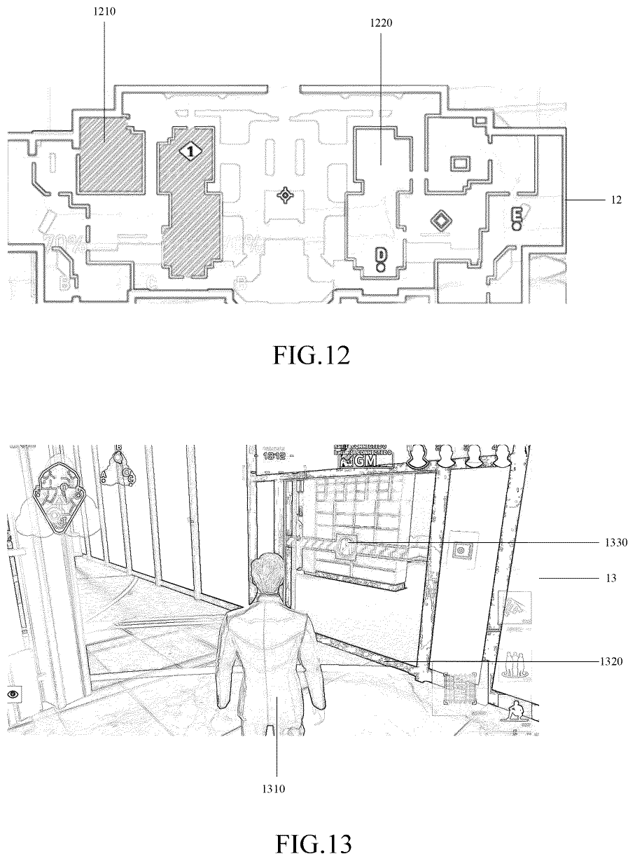

In an example, reference is made to FIG. 12, which illustrates a schematic diagram of a game map provided in an embodiment of the present disclosure. A game interface is displayed by the graphical user interface of the terminal, and a game map 12 may be displayed in the game interface. When the player character moves in the game scene, the terminal may acquire the identity attribute corresponding to the clothing currently worn by the player character and the area identity corresponding to each scene area in the game scene. And then the terminal determines the disguise passage level corresponding to each scene area from the preset passage level table based on the identity attribute and the area identity, and perform the differential display in the game map. For example, an illegal passage area 1201 (the departure area and the illegal area) may be highlighted in the game map. As an example, the illegal passage area 1201 is shown as being highlighted or shown with the slashes, etc., thereby forming a differential display from a regular passage area 1202. In this way, the player can learn passage conditions of the clothing corresponding to the current identity attribute in the game scene, which in turn helps the player to make corresponding game decisions.

In an embodiment of the present disclosure, the terminal may acquire a current disguise passage level of the player character in response to detecting that the player character enters a target scene area, and if the current disguise passage level indicates that the target scene area is the illegal passage area, output prompt information for the player character in the graphical user interface. The prompt information is information that prompts that current clothing of the player character does not satisfy a disguise requirement of the target scene area. In this case, the player may control the player character to leave the current scene area to acquire clothing that allows the player character to pass freely, or dress up clothing in the backpack that matches the scene area, or continue moving in the scene area.

In a case where the player character's current clothing does not match the scene area where the player character is currently moving, if the player continues to control the player character to move in the scene area, during the movement of the player character in the illegal passage area, the terminal may; in response to detecting that the movement behavior of the player character is in a field of view of the non-player character in the illegal passage area, control the non-player character to attack the player character, and issue the illegal alarm against the player character. Alternatively; during the movement of the player character in the illegal passage area, the terminal may, in response to detecting that the player character has not left the illegal passage area within a preset time period, issue the illegal alarm against the player character. The illegal alarm is configured to prompt the opposite player with the position information of the player character, and the term “opposite player” means that a player on the opposite side of the game, or a player that is not in the same team, or a player on the enemy side of the game, etc.

Specifically, for a specific scene area in the game scene, such as the occupation area and the intersection area, the player character is required to wear clothing with an identity attribute that matches the scene area, so as to pass freely in this scene area, which is not easily discovered by the enemy player character or the non-player character in this scene area. In order to improve the diversity of gameplay; the player may make the player character move in the departure area or the illegal area in a case that the player character does not wear the clothing with the corresponding identity attribute. However, due to the failure of the player character's disguise, the terminal will monitor the movement behavior of the player character in this case. If the player character does not leave the departure area or the illegal area within a certain period of time, or the player character is discovered by the non-player characters in these areas, an alarm will be triggered to prompt the enemy player character (report the position of the player character to the enemy player character), and the player character is attacked by the non-player characters in these areas. In this way, the player is required in the game to perform the corresponding dress-up of the player character to acquire the corresponding passage right, which enriches the playability and fun of the game.

For a prompt about a prohibited area for the player character, on the one hand, different scene areas may be differentially displayed through the game map. On the other hand, the current orientation of the player character in the game scene may also be acquired, and the presentation field-of-view picture of the game scene in the graphical user interface may be determined based on the current orientation. Then, in response to detecting that an area boundary between the regular passage area and the illegal passage area exists in the presentation field-of-view picture, a target relative distance between the player character and the area boundary is acquired. If the target relative distance is less than or equal to the preset distance threshold, danger prompt information against the illegal passage area is displayed at the area boundary.

In the game scene, the area boundary may be provided at a boundary between two adjacent different scene areas to realize the division of scene areas. In turn, as the player character moves in the game scene, the terminal may acquire an area identity corresponding to the current scene area where the player character is located. Moreover, when the player character moves to the area boundary of two scene areas, if the adjacent scene areas are the illegal passage areas (such as the departure area or the illegal area), the terminal may acquire the relative distance between the player character and the area boundary, and display the danger prompt information against the illegal passage area at the area boundary: The danger prompt information can remind the player to whom the player character belongs to that there is a risk in entering this scene area with the clothing corresponding to the current identity attribute, thus prompting the player to control the player character to leave the current scene area to acquire clothing that allows the player character to pass freely, or dress up clothing in the backpack that matches the scene area, or continue moving in the scene area.

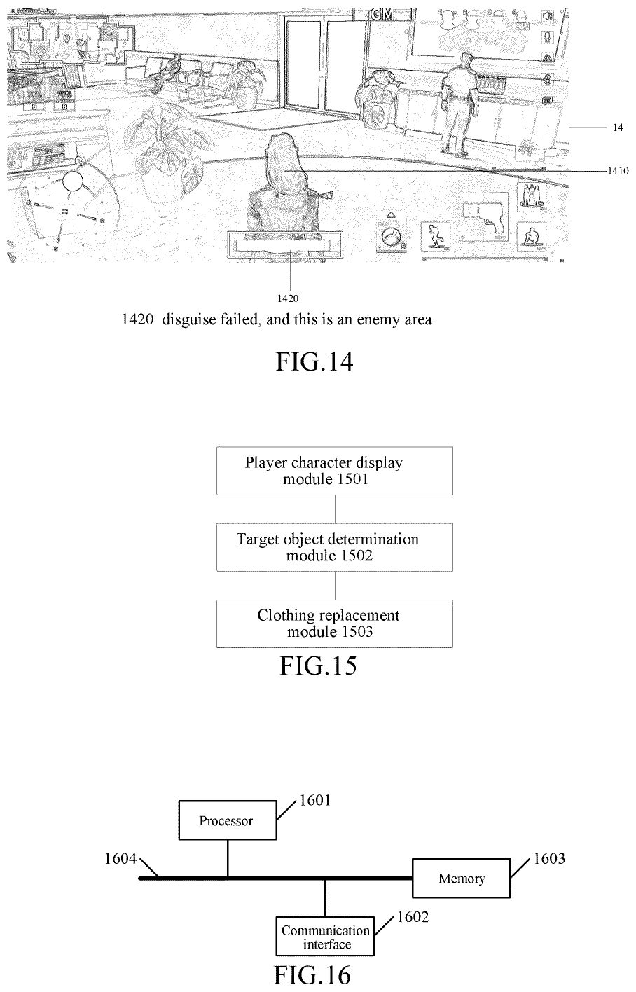

In an example, reference is made to FIG. 13, which illustrates a schematic diagram of a game interface provided in an embodiment of the present disclosure. A game interface 13 is displayed by the graphical user interface of the terminal, and the game interface 13 may include a player character 1310. In a case that the player controls the player character 1310 to move to the area boundary 1320 of two scene areas, and the adjacent scene areas are the illegal passage areas, if a relative distance between the area boundary 1320 and the player character 1310 is less than or equal to 3 meters, and an angle between the player character's current orientation and the area boundary is less than or equal to 45°, danger prompt information 1330 may be displayed at a position corresponding to the area boundary 1320 to remind the player that entering the area with the clothing corresponding to the current identity attribute is dangerous and there is a need to control the player character to acquire the clothing with the corresponding identity attribute, or dress up the clothing in the backpack that matches the scene area. If the player ignores the danger prompt information and continues to control the player character to enter the scene area, the terminal may display the corresponding prompt information in the graphical user interface after the player character enters this scene area. Reference is made to FIG. 14, which illustrates a schematic diagram of a game interface provided in an embodiment of the present disclosure. A game interface 14 is displayed by the graphical user interface of the terminal, and the game interface 14 may include a player character 1410. Clothing currently worn by the player character 1410 that represents the identity attribute does not match the current scene area, and the terminal will display the corresponding prompt information 1420 “disguise failed, and this is an enemy area” in the graphical user interface, etc., in order to prompt the player to control the player character to leave the current scene area to acquire clothing with the corresponding identity attribute, otherwise the player character is easily to be discovered by the non-player character in the current area or by the enemy player character. Therefore, in the game, when it is detected that the clothing currently worn by the player character that represents the identity attribute does not match the scene area where the player character is located, the player is prompted to control the player character to leave the current scene area to acquire clothing that allows the player character to pass freely, or dress up clothing in the backpack that matches the scene area, which facilitates, through the prompt information, the player to make the corresponding game decision, and improve the game experience.

It should be noted that embodiments of the present disclosure include but are not limited to the above examples. It can be understood that under the guidance of the idea of embodiments of the present disclosure, the corresponding determination process may also be implemented by setting other thresholds, conditions, etc., which is not limited by the present disclosure.

In embodiments of the present disclosure, the terminal may display the player character wearing the initial clothing through the graphical user interface. During the game, the terminal may determine the disguisable target object in the current game scene where the player character is located, and then in response to the preset operation instruction, control the player character to acquire the target clothing, the target clothing represents the identity attribute corresponding to the disguisable target object, and replace the initial clothing of the player character with the target clothing. Therefore, by associating the identity attribute with the clothing in the game, the player can acquire the corresponding target clothing used to represent the corresponding identity attribute through the disguisable target object, realizing the dress-up of the player character and enriching the diversity of the game character dress-up, which can satisfy different needs of the player. In addition, providing the more interesting dress-up manner allows the player to “disguise” the game character through the target clothing in the game. Different areas are displayed differentially in the game map according to the player character's current clothing, so that the player can learn passage conditions of the current clothing in different areas, which facilitates the player to make corresponding game decisions, and improves the fun and experience of the game.

It should be noted that, for the method embodiments, for the sake of simple description, they are all expressed as a series of action combinations, but those skilled in the art should understand that embodiments of the present disclosure are not limited by the described action sequence, because certain steps may be performed in other sequences or concurrently in accordance with embodiments of the present disclosure. Secondly, those skilled in the art should also understand that embodiments described in the specification are all preferred embodiments, and actions involved are not necessarily required in embodiments of the present disclosure.

Reference is made to FIG. 15, which illustrates a structural block diagram of an apparatus for game interaction provided in an embodiment of the present disclosure is shown. A graphical user interface is provided by an electronic terminal, and a content displayed by the graphical user interface includes a game scene, a player character, and a plurality of non-player characters located in the game scene. The non-player characters wear clothing representing identity attributes, and clothing corresponding to different identity attributes has different clothing styles. The non-player characters act in the game scene according to a default action logic. The apparatus may specifically include the following modules:
a player character display module 1501, configured to display the player character wearing initial clothing through the graphical user interface;
a target object determination module 1502, configured to determine a disguisable target object in a current game scene where the player character is located, wherein the disguisable target object includes at least one of: the non-player character wearing clothing representing an identity attribute or a virtual item that includes the clothing representing the identity attribute; and
a clothing replacement module 1503, configured to, in response to a preset operation instruction, control the player character to acquire target clothing, the target clothing represents the identity attribute corresponding to the disguisable target object, and replace the initial clothing of the player character with the target clothing to make the player character wear the same clothing as the clothing representing the identity attribute corresponding to the disguisable target object.

In an embodiment of the present disclosure, the target object determination module 1502 includes:
a presentation field-of-view picture determination sub-module, configured to acquire a current orientation of the player character in the game scene, and determine, according to the current orientation, a presentation field-of-view picture of the current game scene in the graphical user interface; and
a target object display sub-module, configured to display the disguisable target object if it is detected that the disguisable target object exists in the presentation field-of-view picture.

In an embodiment of the present disclosure, the target object determination module 1502 includes:
a player character attack sub-module, configured to, in response to an attack instruction that controls the player character to attack the non-player character, determine a first target non-player character, and control the player character to attack the first target non-player character; and
a target object determination sub-module, configured to, in response to the player character successfully attacking the first target non-player character, place the first target non-player character in a downed state to make the first target non-player character become the disguisable target object.

In an embodiment of the present disclosure, the player character attack sub-module is specifically configured to:
acquire first position information between the player character and the first target non-player character in the game scene, and the first position information at least includes a first relative distance and a first relative angle;
display an attack control in the graphical user interface, if the first relative distance is less than or equal to a preset distance threshold, and the first relative angle is less than or equal to a preset angle threshold; and
control the player character to attack the first target non-player character in response to a touch operation for the attack control.

In an embodiment of the present disclosure, the player character attack sub-module is specifically configured to:
in response to the touch operation for the attack control, control the player character to perform a first attack for the first target non-player character if the player character is located in front of the first target non-player character; and
control the player character to perform a second attack for the first target non-player character if the player character is located behind the first target non-player character.

In an embodiment of the present disclosure, an attack duration of the first attack is longer than an attack duration of the second attack.

In an embodiment of the present disclosure, the content displayed by the graphical user interface further includes a skill control, and the clothing replacement module 1503 includes:
a clothing copy sub-module, configured to, in response to a touch operation for the skill control, control the player character to copy the target clothing, the target clothing represents the identity attribute corresponding to the disguisable target object, and replace the initial clothing of the player character with the target clothing to make the player character wear the same clothing as the clothing representing the identity attribute corresponding to the disguisable target object.

In an embodiment of the present disclosure, the clothing replacement module 1503 includes:
a second position information acquisition sub-module, configured to acquire a second position information between the player character and the disguisable target object in the current game scene, and the second position information includes a second relative distance and a second relative angle;
a dress-up control display sub-module, configured to display in the graphical user interface a dress-up control for the disguisable target object if the second position information satisfies a first preset condition; and
a dress-up control response sub-module, configured to, in response to a touch operation for the dress-up control, control the player character to acquire the target clothing, the target clothing represents the identity attribute corresponding to the disguisable target object, and replace the initial clothing of the player character with the target clothing to make the player character wear the same clothing as the clothing representing the identity attribute corresponding to the disguisable target object.

In an embodiment of the present disclosure, the apparatus further includes:
an identity attribute acquisition module, configured to acquire a current identity attribute corresponding to clothing currently worn by the player character, and a target identity attribute corresponding to the disguisable target object; and
a dress-up control processing sub-module, configured to set the dress-up control to an inoperable state if the current identity attribute is the same as the target identity attribute.

In an embodiment of the present disclosure, the dress-up control response sub-module is specifically configured to:
in response to the touch operation for the dress-up control, control the player character to acquire the target clothing representing the identity attribute from the virtual item, and replace the initial clothing of the player character with the target clothing to make the player character wear the same clothing as the clothing representing the identity attribute corresponding to the disguisable target object; and
remove the virtual item from the graphical user interface.

In an embodiment of the present disclosure, the dress-up control response sub-module is specifically configured to:
in response to the touch operation for the dress-up control, control the player character to acquire the target clothing representing the identity attribute from the non-player character, and replace the initial clothing of the player character with the target clothing to make the player character wear the same clothing as the clothing representing the identity attribute corresponding to the disguisable target object; and
remove the target clothing worn by the non-player character, leaving the non-player character in an undressed state.

In an embodiment of the present disclosure, the apparatus further includes:
a clothing processing module, configured to, in response to detecting that the player character has completed dressing up, put the initial clothing into a backpack corresponding to the player character, or remove the initial clothing from the player character and display in the current game scene a target virtual item corresponding to the initial clothing; and
the target virtual item is only visible to a user to whom the player character belongs.

In an embodiment of the present disclosure, the second position information includes the second relative distance and the second relative angle, and the dress-up control display sub-module is specifically configured to:
display in the graphical user interface the dress-up control and a carrying control for the disguisable target object, if the second relative distance is less than or equal to a preset distance threshold and the second relative angle is less than or equal to a preset angle threshold.

In an embodiment of the present disclosure, the non-player character wearing the clothing representing the identity attribute includes a second target non-player character in a downed state, and the apparatus further includes:
a non-player character carrying module, configured to, in response to a touch operation for the carrying control, control the player character to carry the second target non-player character, and set the second target non-player character to an un-selectable state.

In an embodiment of the present disclosure, the non-player character carrying module is specifically configured to:
in response to the touch operation for the carrying control, control the player character to carry, at a preset movement speed, the second target non-player character.

In an embodiment of the present disclosure, the non-player character carrying module is specifically configured to:
in response to the touch operation for the carrying control, acquire a character state of the second target non-player character; and
control the player character to carry the second target non-player character, if the character state indicates that the second target non-player character is in a selectable state.

In an embodiment of the present disclosure, the apparatus further includes:
a threat value increasing module, configured to, in a process of the player character carrying the second target non-player character, determine that a position where the player character is located is within a preset range of another non-player character, and increase a threat value of the other non-player character to the player character.

In an embodiment of the present disclosure, the apparatus further includes:
a non-player character control module, configured to control a non-player character whose threat value is greater than or equal to a preset threat threshold to change from the default action logic to a target logic, and control, according to the target logic, the non-player character to perform a target behavior for the player character.

In an embodiment of the present disclosure, the apparatus further includes:
an alarm processing module, configured to, in a process of the player character carrying the second target non-player character, if a carrying action of the player character is within a preset range of another non-player character, change the other non-player character from the default action logic to a target logic, control, according to the target logic, the other non-player character to perform a target action for the player character and issue an illegal alarm against the player character;
the illegal alarm is configured to prompt an opposite player with position information of the player character.

In an embodiment of the present disclosure, the apparatus further includes:
an information acquisition module, configured to, in a process of the player character carrying the second target non-player character, in response to detecting presence of a storage object in the current game scene, acquire third position information between the storage object and the player character, and a storage state of the storage object;
a storage control display module, configured to, display in the graphical user interface a storage control corresponding to the storage object if the third position information and the storage state satisfy a second preset condition; and
a non-player character processing module, configured to control the player character to carry the second target non-player character into the storage object in response to a touch operation for the storage control.

In an embodiment of the present disclosure, the third position information includes a third relative distance and a third relative angle, and the storage control display module is specifically configured to:
display in the graphical user interface the storage control corresponding to the storage object, if the third relative distance is less than or equal to the preset distance threshold, the third relative angle is less than or equal to the preset angle threshold, and the storage state indicates that a number of non-player characters stored by the storage object is less than a preset number threshold.

In an embodiment of the present disclosure, the apparatus further includes:
an interrupt control display module, configured to, in the process of the player character carrying the second target non-player character, or in a process of the player character carrying the second target non-player character into the storage object, display an interrupt control in the graphical user interface; and
an interrupt control response module, configured to, in response to a touch operation for the interrupt control, control the player character to stop carrying the second target non-player character or stop carrying the second target non-player character to the storage object, and set a state of the second target non-player character to a selectable state.

In an embodiment of the present disclosure, the apparatus further includes:
a carrying stop module, configured to, in the process of the player character carrying the second target non-player character, in response to detecting that a carrying operation of the player character is interrupted, control the player character to stop carrying the second target non-player character, and set a state of the second target non-player character to a selectable state: or in a process of the player character moving the second target non-player character into the storage object, in response to detecting that the carrying operation of the player character is interrupted, control the player character to stop carrying the second target non-player character, and set the state of the second target non-player character to the selectable state.

In an embodiment of the present disclosure, the content displayed by the graphical user interface further includes a game map including different scene areas of the game scene, and the apparatus further includes:
an attribute and identity acquisition module, configured to acquire a current identity attribute corresponding to clothing currently worn by the player character, and an area identity of each scene area; and
a differential display module, configured to differentially display the scene areas in the game map according to the current identity attribute and the area identity.

In an embodiment of the present disclosure, the differential display module includes:
a passage level determination sub-module, configured to query from a preset passage level table a disguise passage level corresponding to each area identity by using the current identity attribute; and
a differential display sub-module, configured to divide, according to the disguise passage level, the scene areas in the game map into a regular passage area and an illegal passage area and setting the illegal passage area to a different display style from the regular passage area.

In an embodiment of the present disclosure, the apparatus further includes:
a field-of-view picture determination module, configured to acquire a current orientation of the player character in the game scene, and determining a presentation field-of-view picture of the game scene in the graphical user interface according to the current orientation;
a relative distance acquisition module, configured to acquire a target relative distance between the player character and an area boundary, in response to detecting that the area boundary between the regular passage area and the illegal passage area exists in the presentation field-of-view picture; and
a danger prompt information display module, configured to display at the area boundary danger prompt information against the illegal passage area if the target relative distance is less than or equal to a preset distance threshold.

In an embodiment of the present disclosure, the apparatus further includes:
a pass level acquisition module, configured to acquire a current disguise passage level of the player character in response to detecting that the player character enters a target scene area; and
a prompt information display module, configured to, if the current disguise passage level indicates that the target scene area is the illegal passage area, output in the graphical user interface prompt information for the player character, and the prompt information is information that prompts that current clothing of the player character does not satisfy a disguise requirement of the target scene area.

In an embodiment of the present disclosure, the apparatus further includes:
a first alarm output module, configured to, during movement of the player character in the illegal passage area, in response to detecting that a movement behavior of the player character falls into a field of view of a non-player character in the illegal passage area, control the non-player character to attack the player character, and issue an illegal alarm against the player character.

In an embodiment of the present disclosure, the apparatus further includes:
a second alarm output module, configured to, during movement of the player character in the illegal passage area, issue an illegal alarm against the player character in response to detecting that the player character has not left the illegal passage area within a preset time period.

In an embodiment of the present disclosure, the illegal alarm is configured to prompt an opposite player with position information of the player character.

For the apparatus embodiment, since it is basically similar to the method embodiment, the description is relatively simple, and the relevant parts can be referred to the description of the method embodiment.

In addition, embodiments of the present disclosure further provide an electronic device, including a processor 1601, a communication interface 1602, a memory 1603, and a communication bus 1604, as shown in FIG. 16. The processor 1601, the communication interface 1602, and the memory 1603 complete communication with each other through the communication bus 1604.

The memory 1603 is configured to store a computer program.

The processor 1601 is configured to implement the following steps when executing the program stored in the memory 1603:
in response to a preset operation instruction, controlling the player character to acquire target clothing, the target clothing represents the identity attribute corresponding to the disguisable target object, and replacing initial clothing of the player character with the target clothing to make the player character wear the same clothing as the clothing representing the identity attribute corresponding to the disguisable target object.

In some embodiments of the present disclosure, the determining the disguisable target object in the current game scene where the player character is located includes:
acquiring a current orientation of the player character in the game scene, and determining a presentation field-of-view picture of the current game scene in the graphical user interface according to the current orientation; and
if it is detected that the disguisable target object exists in the presentation field-of-view picture, displaying the disguisable target object.

In some embodiments of the present disclosure, the determining the disguisable target object in the current game scene where the player character is located includes:
in response to an attack instruction that controls the player character to attack a non-player character, determining a first target non-player character, and controlling the player character to attack the first target non-player character; and
in response to the player character successfully attacking the first target non-player character, placing the first target non-player character in a downed state to make the first target non-player character become the disguisable target object.

In some embodiments of the present disclosure, the in response to the attack instruction that controls the player character to attack the non-player character, determining the first target non-player character, and controlling the player character to attack the first target non-player character includes:
acquiring first position information between the player character and the first target non-player character in the game scene, and the first position information at least includes a first relative distance and a first relative angle;
if the first relative distance is less than or equal to a preset distance threshold, and the first relative angle is less than or equal to the preset angle threshold, displaying an attack control in the graphical user interface; and
in response to a touch operation for the attack control, controlling the player character to attack the first target non-player character.

In some embodiments of the present disclosure, the in response to the touch operation for the attack control, controlling the player character to attack the first target non-player character includes:
in response to the touch operation for the attack control, controlling the player character to perform a first attack for the first target non-player character if the player character is located in front of the first target non-player character; and
controlling the player character to perform a second attack for the first target non-player character if the player character is located behind the first target non-player character.

In some embodiments of the present disclosure, an attack duration of the first attack is longer than an attack duration of the second attack.

In some embodiments of the present disclosure, the content displayed by the graphical user interface further includes a skill control, and the in response to the preset operation instruction, controlling the player character to acquire the target clothing, the target clothing represents the identity attribute corresponding to the disguisable target object, and replacing the initial clothing of the player character with the target clothing to make the player character wear the same clothing as the clothing representing the identity attribute corresponding to the disguisable target object includes:
in response to the touch operation for the skill control, controlling the player character to copy the target clothing, the target clothing represents the identity attribute corresponding to the disguisable target object, and replacing the initial clothing of the player character with the target clothing to make the player character wear the same clothing as the clothing representing the identity attribute corresponding to the disguisable target object.

In some embodiments of the present disclosure, the in response to the preset operation instruction, controlling the player character to acquire the target clothing, the target clothing represents the identity attribute corresponding to the disguisable target object, and replacing the initial clothing of the player character with the target clothing to make the player character wear the same clothing as the clothing representing the identity attribute corresponding to the disguisable target object includes:
acquiring a second position information between the player character and the disguisable target object in the current game scene, and the second position information includes a second relative distance and a second relative angle; and
if the second position information satisfies a first preset condition, displaying in the graphical user interface a dress-up control for the disguisable target object; and
in response to a touch operation for the dress-up control, controlling the player character to acquire the target clothing, the target clothing represents the identity attribute corresponding to the disguisable target object, and replacing the initial clothing of the player character with the target clothing to make the player character wear the same clothing as the clothing representing the identity attribute corresponding to the disguisable target object.

In some embodiments of the present disclosure, after displaying in the graphical user interface the dress-up control for the disguisable target object, the method further includes:
acquiring a current identity attribute corresponding to clothing currently worn by the player character, and a target identity attribute corresponding to the disguisable target object; and
if the current identity attribute is the same as the target identity attribute, setting the dress-up control to an inoperable state.

In some embodiments of the present disclosure, the in response to the touch operation for the dress-up control, controlling the player character to acquire the target clothing, the target clothing represents the identity attribute corresponding to the disguisable target object, and replacing the initial clothing of the player character with the target clothing to make the player character wear the same clothing as the clothing representing the identity attribute corresponding to the disguisable target object includes:
in response to a touch operation for the dress-up control, controlling the player character to acquire the target clothing representing the identity attribute from the virtual item, and replacing the initial clothing of the player character with the target clothing to make the player character wear the same clothing as the clothing representing the identity attribute corresponding to the disguisable target object; and
removing the virtual item from the graphical user interface.

In some embodiments of the present disclosure, the in response to the touch operation for the dress-up control, controlling the player character to acquire the target clothing representing the identity attribute from the virtual item, and replacing the initial clothing of the player character with the target clothing to make the player character wear the same clothing as the clothing representing the identity attribute corresponding to the disguisable target object includes:
in response to the touch operation for the dress-up control, controlling the player character to acquire the target clothing representing the identity attribute from the non-player character, and replacing the initial clothing of the player character with the target clothing to make the player character wear the same clothing as the clothing representing the identity attribute corresponding to the disguisable target object; and
removing the target clothing worn by the non-player character, leaving the non-player character in an undressed state.

In some embodiments of the present disclosure, the method further includes:
in response to detecting that the player character has completed dressing up, putting the initial clothing into a backpack corresponding to the player character, or removing the initial clothing from the player character and displaying in the current game scene a target virtual item corresponding to the initial clothing;
the target virtual item is only visible to a user to whom the player character belongs.

In some embodiments of the present disclosure, the second position information includes a second relative distance and a second relative angle, and the if the position information satisfies the preset condition, displaying in the graphical user interface the dress-up control for the disguisable target object includes:
if the second relative distance is less than or equal to a preset distance threshold and the second relative angle is less than or equal to a preset angle threshold, displaying in the graphical user interface the dress-up control and a carrying control for the disguisable target object.

In some embodiments of the present disclosure, the non-player character wearing the clothing representing the identity attribute includes a second target non-player character in a downed state, and the method further includes:
in response to a touch operation for the carrying control, controlling the player character to carry the second target non-player character, and setting the second target non-player character to an un-selectable state.

In some embodiments of the present disclosure, the in response to the touch operation for the carrying control, controlling the player character to carry the second target non-player character includes:
in response to a touch operation for the carrying control, controlling the player character to carry, at a preset movement speed, the second target non-player character.

In some embodiments of the present disclosure, the in response to the touch operation for the carrying control, controlling the player character to carry the second target non-player character includes:
in response to the touch operation for the carrying control, acquiring a character state of the second target non-player character; and
if the character state indicates that the second target non-player character is in a selectable state, controlling the player character to carry the second target non-player character.

In some embodiments of the present disclosure, the method further includes:
in a process of the player character carrying the second target non-player character, determining that a position of the player character is within a preset range of another non-player character, and increasing a threat value of the other non-player character to the player character.

In some embodiments of the present disclosure, the method further includes:
controlling a non-player character whose threat value is greater than or equal to a preset threat threshold to change from the default action logic to a target logic, and controlling, according to the target logic, the non-player character to perform a target behavior for the player character.

In some embodiments of the present disclosure, the method further includes:
in a process of the player character carrying the second target non-player character, if a carrying action of the player character is within a preset range of another non-player character, changing the other non-player character from the default action logic to the target logic, controlling, according to the target logic, the other non-player character to perform the target behavior for the player character and issuing an illegal alarm against the player character;
the illegal alarm is configured to prompt an opposite player with position information of the player character.

In some embodiments of the present disclosure, the method further includes:
in a process of the player character carrying the second target non-player character, in response to detecting presence of a storage object in the current game scene, acquiring third position information between the storage object and the player character, and a storage state of the storage object;
if the third position information and the storage state satisfy a second preset condition, displaying in the graphical user interface a storage control corresponding to the storage object; and
in response to a touch operation for the storage control, controlling the player character to carry the second target non-player character into the storage object.

In some embodiments of the present disclosure, the third position information includes a third relative distance and a third relative angle, and the if the third position information and the storage state satisfy the second preset condition, displaying in the graphical user interface the storage control corresponding to the storage object includes:
if the third relative distance is less than or equal to the preset distance threshold, the third relative angle is less than or equal to the preset angle threshold, and the storage state indicates that a number of non-player characters stored by the storage object is less than a preset number threshold, displaying in the graphical user interface the storage control corresponding to the storage object.

In some embodiments of the present disclosure, the method further includes:
in a process of the player character carrying the second target non-player character, or in a process of the player character carrying the second target non-player character into the storage object, displaying an interrupt control in the graphical user interface; and
in response to a touch operation for the interrupt control, controlling the player character to stop carrying the second target non-player character, or controlling the player character to stop carrying the second target non-player character to the storage object, and setting a state of the second target non-player character to a selectable state.

In some embodiments of the present disclosure, the method further includes:
in a process of the player character carrying the second target non-player character, in response to detecting that a carrying operation of the player character is interrupted, controlling the player character to stop carrying the second target non-player character, and setting a state of the second target non-player character to a selectable state: or
in a process of the player character moving the second target non-player character into the storage object, in response to detecting that the carrying operation of the player character is interrupted, controlling the player character to stop carrying the second target non-player character, and setting the state of the second target non-player character to the selectable state.

In some embodiments of the present disclosure, the content displayed by the graphical user interface further includes a game map including different scene areas of the game scene, and the method further includes:
acquiring a current identity attribute corresponding to clothing currently worn by the player character, and an area identity of each scene area; and
differentially displaying the scene area in the game map according to the current identity attribute and the area identity.

In some embodiments of the present disclosure, the differentially displaying the scene area in the game map according to the current identity attribute and the area identity includes:
querying a disguise passage level corresponding to each area identity from a preset passage level table by using the current identity attribute; and
dividing in the game map the scene area into a regular passage area and an illegal passage area according to the disguise passage level, and setting the illegal passage area to a different display style from the regular passage area.

In some embodiments of the present disclosure, the method further includes:
acquiring a current orientation of the player character in the game scene, and determining a presentation field-of-view picture of the game scene in the graphical user interface according to the current orientation;
in response to detecting that an area boundary between the regular passage area and the illegal passage area exists in the presentation field-of-view picture, acquiring a target relative distance between the player character and the area boundary; and
if the target relative distance is less than or equal to a preset distance threshold, displaying at the area boundary danger prompt information against the illegal passage area.

In some embodiments of the present disclosure, the method further includes:
in response to detecting that the player character enters the target scene area, acquiring a current disguise passage level of the player character; and
if the current disguise passage level indicates that a target scene area is the illegal passage area, outputting prompt information for the player character in the graphical user interface, and the prompt information is information that prompts that current clothing of the player character does not satisfy a disguise requirement of the target scene area.

In some embodiments of the present disclosure, the method further includes:
during movement of the player character in the illegal passage area, in response to detecting that a movement behavior of the player character falls into a field of view of a non-player character in the illegal passage area, controlling the non-player character to attack the player character, and issuing an illegal alarm against the player character.

In some embodiments of the present disclosure, the method further includes:
during movement of the player character in the illegal passage area, in response to detecting that the player character has not left the illegal passage area within a preset time period, issuing an illegal alarm against the player character.

In some embodiments of the present disclosure, the illegal alarm is configured to prompt an opposite player with position information of the player character.

The communication bus mentioned in the above terminal may be a Peripheral Component Interconnect (PCI) bus, an Extended Industry Standard Architecture (EISA) bus, or the like. The communication bus may be classified into an address bus, a data bus, a control bus, and the like. For ease of representation, only one thick line is used to represent the bus in the figure, but this does not mean that there is only one bus or only one type of bus.

The communication interface is used for communication between the above terminal and other devices.

The memory may include a Random Access Memory (RAM) or a non-volatile memory, such as at least one disk memory. In some embodiments of the present disclosure, the memory may also be at least one storage device located far away from the aforementioned processor.

The above-mentioned processor may be a general-purpose processor, including a Central Processing Unit (CPU), a Network Processor (NP), etc.; it may also be a Digital Signal Processing (DSP), an Application Specific Integrated Circuit (ASIC), a Field-Programmable Gate Array (FPGA) or other programmable logic devices, a discrete gate or a transistor logic device, and a discrete hardware component.

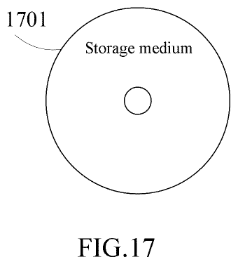

As shown in FIG. 17, there is further provided a non-transitory computer-readable storage medium 1701 in yet another embodiment provided by the present disclosure. The non-transitory computer-readable storage medium stores instructions that, when run on a computer, cause the computer to execute the method for game interaction described in the above embodiments.

In still another embodiment provided by the present disclosure, there is further provided a computer program product containing instructions that, when run on a computer, cause the computer to execute the method for game interaction described in the above embodiments.

In the above embodiments, the functions may be implemented, in whole or in part, via software, hardware, firmware or any combination thereof. When implemented by software, the functions may be implemented in whole or in part in a form of a computer program product. The computer program product includes one or more computer instructions. When the computer program instructions are loaded and executed on a computer, the flows or functions described in accordance with embodiments of the present disclosure are generated in whole or in part. The computer can be a general purpose computer, a special purpose computer, a computer network, or other programmable devices. The computer instructions may be stored in a computer readable storage medium or transferred from one computer readable storage medium to another computer readable storage medium. For example, the computer instructions can be transferred from a website site, computer, server or data center to another website site, computer, server, or data center by wire (e.g., coaxial cable, fiber optic, Digital Subscriber Line (DSL)), or wireless (e.g., infrared, wireless, microwave, etc.). The computer readable storage medium may be any available media that may be accessed by a computer, or a data storage device such as a server, or a data center that includes one or more available media integrated. The available medium may be a magnetic medium (e.g., a floppy disk, a hard disk, a magnetic tape), an optical medium (e.g., a Digital Video Disc, DVD), or a semiconductor medium (such as a Solid State Disk (SSD)) or the like.

It should be noted that relational terms such as first and second herein are used merely to distinguish one entity or operation from another entity or operation herein, and do not necessarily require or imply the existence of any such actual relationship or order between these entities or operations. Moreover, the terms “include”, “contain” or any other variations thereof are intended to cover a non-exclusive inclusion, such that a process, method, article or device including a series of elements not only includes those elements, but also includes those elements that are not explicitly listed, or includes elements inherent to such a process, method, article or device. Under the condition of no more limitations, it is not excluded that additional identical elements exist in the process, method, article or device including elements defined by a sentence “including a . . . ”.

Respective embodiments in the specification are described in a related manner. The same and similar parts between the respective embodiments may be referred to each other. Each embodiment focuses on its differences from other embodiments. In particular, for the system embodiment, since it is basically similar to the method embodiment, the description is relatively simple. For the relevant parts, reference may be made to the partial description of the method embodiment.

The above descriptions are only preferred embodiments of the present disclosure and are not intended to limit the scope of the present disclosure. Any modifications, equivalent substitutions, improvements, etc. made within the spirit and principles of the present disclosure are included in the protection scope of the present disclosure.

1. A method for game interaction, comprising:
displaying a player character wearing initial clothing through a graphical user interface provided by an electronic terminal, wherein a content displayed by the graphical user interface comprises a game scene, the player character, and a non-player character located in the game scene and acting in the game scene according to a default action logic, wherein the non-player character wears clothing representing an identity attribute, and clothing corresponding to different identity attributes has different clothing styles;
determining a disguisable target object in a current game scene where the player character is located, wherein the disguisable target object comprises at least one of: the non-player character wearing the clothing representing the identity attribute, or a virtual item that comprises the clothing representing the identity attribute; and
in response to a preset operation instruction, controlling the player character to acquire target clothing, wherein the target clothing represents the identity attribute corresponding to the disguisable target object, and replacing the initial clothing of the player character with the target clothing to make the player character wear the same clothing as the clothing representing the identity attribute corresponding to the disguisable target object.

2. The method according to claim 1, wherein determining the disguisable target object in the current game scene where the player character is located comprises:
acquiring a current orientation of the player character in the current game scene, and determining, according to the current orientation, a presentation field-of-view picture of the current game scene in the graphical user interface; and
displaying the disguisable target object in response to detecting that the disguisable target object exists in the presentation field-of-view picture.

3. The method according to claim 1, wherein determining the disguisable target object in the current game scene where the player character is located comprises:
in response to an attack instruction for controlling the player character to attack the non-player character, determining a first target non-player character, and controlling the player character to attack the first target non-player character; and
in response to the player character successfully attacking the first target non-player character, placing the first target non-player character in a downed state and determining the first target non-player character as the disguisable target object;
wherein in response to the attack instruction for controlling the player character to attack the non-player character, determining the first target non-player character, and controlling the player character to attack the first target non-player character comprises:
acquiring first position information between the player character and the first target non-player character in the game scene, wherein the first position information comprises a first relative distance and a first relative angle;
in response to determining that the first relative distance is less than or equal to a preset distance threshold, and the first relative angle is less than or equal to a preset angle threshold, displaying an attack control in the graphical user interface; and
controlling the player character to attack the first target non-player character in response to a touch operation for the attack control;
wherein controlling the player character to attack the first target non-player character in response to the touch operation for the attack control comprises:
in response to the touch operation for the attack control, controlling the player character to perform a first attack for the first target non-player character in response to determining that the player character is located in front of the first target non-player character; and
controlling the player character to perform a second attack for the first target non-player character in response to determining that the player character is located behind the first target non-player character; and
wherein an attack duration of the first attack is longer than an attack duration of the second attack.

4-6. (canceled)

7. The method according to claim 1, wherein the method further comprises:
in response to a touch operation for the skill control, controlling the player character to copy the target clothing, wherein the target clothing represents the identity attribute corresponding to the disguisable target object, and replacing the initial clothing of the player character with the target clothing to make the player character wear the same clothing as the clothing representing the identity attribute corresponding to the disguisable target object.

8. The method according to claim 1, further comprising:
acquiring a second position information between the player character and the disguisable target object in the current game scene, wherein the second position information comprises a second relative distance and a second relative angle;
displaying in the graphical user interface a dress-up control for the disguisable target object in response to determining that the second position information satisfies a first preset condition; and
in response to a touch operation for the dress-up control, controlling the player character to acquire the target clothing, wherein the target clothing represents the identity attribute corresponding to the disguisable target object, and replacing the initial clothing of the player character with the target clothing to make the player character wear the same clothing as the clothing representing the identity attribute corresponding to the disguisable target object; and
wherein the method further comprises:
acquiring a current identity attribute corresponding to clothing currently worn by the player character, and a target identity attribute corresponding to the disguisable target object; and
setting the dress-up control to an inoperable state in response to determining that the current identity attribute is the same as the target identity attribute.

9. (canceled)

10. The method according to claim 8, further comprising:
in response to the touch operation for the dress-up control, controlling the player character to acquire the target clothing from the virtual item, and replacing the initial clothing of the player character with the target clothing to make the player character wear the same clothing as the clothing representing the identity attribute corresponding to the disguisable target object; and
removing the virtual item from the graphical user interface.

11. The method according to claim 8, wherein controlling the player character to acquire the target clothing, and replacing the initial clothing of the player character with the target clothing comprises:
in response to the touch operation for the dress-up control, controlling the player character to acquire the target clothing from the non-player character, and replacing the initial clothing of the player character with the target clothing to make the player character wear the same clothing as the clothing representing the identity attribute corresponding to the disguisable target object; and
removing the target clothing worn by the non-player character, and leaving the non-player character in an undressed state.

12. The method according to claim 1, further comprising:
in response to detecting that the player character has completed dressing up, putting the initial clothing into a backpack corresponding to the player character, or removing the initial clothing from the player character and displaying in the current game scene a target virtual item corresponding to the initial clothing; and
wherein the target virtual item is only visible to a player to whom the player character belongs.

13. The method according to claim 8, wherein displaying in the graphical user interface the dress-up control for the disguisable target object in response to determining that the second position information satisfies the first preset condition, comprises:
displaying in the graphical user interface the dress-up control and a carrying control for the disguisable target object, in response to determining that the second relative distance is less than or equal to a preset distance threshold and the second relative angle is less than or equal to a preset angle threshold.

14. The method according to claim 13, wherein the non-player character wearing the clothing representing the identity attribute comprises a second target non-player character in a downed state, and the method further comprises:
in response to a touch operation for the carrying control, controlling the player character to carry the second target non-player character, and setting the second target non-player character to an un-selectable state.

15. The method according to claim 14, wherein in response to the touch operation for the carrying control, controlling the player character to carry the second target non-player character comprises:
in response to the touch operation for the carrying control, controlling the player character to carry, at a preset movement speed, the second target non-player character.

16. The method according to claim 14, wherein in response to the touch operation for the carrying control, controlling the player character to carry the second target non-player character comprises:
in response to the touch operation for the carrying control, acquiring a character state of the second target non-player character; and
controlling the player character to carry the second target non-player character, in response to determining that the character state indicates that the second target non-player character is in a selectable state.

17. The method according to claim 14, further comprising:
in a process of the player character carrying the second target non-player character, in response to determining that a position where the player character is located is within a preset range of another non-player character, increasing a threat value of the other non-player character to the player character.

18. The method according to claim 17, further comprising:
controlling a non-player character whose threat value is greater than or equal to a preset threat threshold to change from the default action logic to a target logic, and
controlling, according to the target logic, the non-player character to perform a target behavior for the player character.

19. The method according to claim 14, further comprising:
in a process of the player character carrying the second target non-player character, in response to determining that a carrying action of the player character is within a preset range of another non-player character, changing the other non-player character from the default action logic to a target logic;
controlling, according to the target logic, the other non-player character to perform a target action for the player character; and
issuing an illegal alarm against the player character;
wherein the illegal alarm is configured to prompt an opposite player with position information of the player character.

20. The method according to claim 14, further comprising:
in a process of the player character carrying the second target non-player character, in response to detecting presence of a storage object in the current game scene, acquiring third position information between the storage object and the player character, and a storage state of the storage object;
displaying in the graphical user interface a storage control corresponding to the storage object in response to determining that the third position information and the storage state satisfy a second preset condition; and
controlling the player character to carry the second target non-player character into the storage object in response to a touch operation for the storage control.

21. The method according to claim 20, wherein the third position information comprises a third relative distance and a third relative angle, and displaying in the graphical user interface the storage control corresponding to the storage object in response to determining that the third position information and the storage state satisfy the second preset condition comprises:
displaying in the graphical user interface the storage control corresponding to the storage object, in response to determining that the third relative distance is less than or equal to the preset distance threshold, the third relative angle is less than or equal to the preset angle threshold, and the storage state indicates that a number of non-player characters stored by the storage object is less than a preset number threshold.

22. The method according to claim 20, further comprising:
in the process of the player character carrying the second target non-player character, or in a process of the player character carrying the second target non-player character into the storage object, displaying an interrupt control in the graphical user interface; and
in response to a touch operation for the interrupt control, controlling the player character to stop carrying the second target non-player character or stop carrying the second target non-player character to the storage object, and setting a state of the second target non-player character to a selectable state.

23. The method according to claim 20, further comprising:
in the process of the player character carrying the second target non-player character, in response to detecting that a carrying operation of the player character is interrupted, controlling the player character to stop carrying the second target non-player character, and setting a state of the second target non-player character to a selectable state; or
in a process of the player character carrying the second target non-player character into the storage object, in response to detecting that the carrying operation of the player character is interrupted, controlling the player character to stop carrying the second target non-player character, and setting the state of the second target non-player character to the selectable state.

24. The method according to claim 1, wherein the content displayed by the graphical user interface further comprises a game map comprising different scene areas of the game scene, and the method further comprises:
acquiring a current identity attribute corresponding to clothing currently worn by the player character, and an area identity of each scene area; and
differentially displaying the scene areas in the game map according to the current identity attribute and the area identity; and
wherein differentially displaying the scene areas in the game map according to the current identity attribute and the area identity comprises:
querying from a preset passage level table a disguise passage level corresponding to each area identity by using the current identity attribute; and
dividing, according to the disguise passage level, the scene areas in the game map into a regular passage area and an illegal passage area and setting the illegal passage area to a different display style from the regular passage area.

25-33. (canceled)
